(19) United States
(12) Patent Application Publication
(10) Pub. No.: US 2009/0017209 A1
(43) Pub. Date: Jan. 15, 2009

(54) PROCESS FOR PREPARING A POWDER COATING COMPOSITION

(76) Inventors: Andrew Robert Morgan, Ryton (GB); Martinus Adrianus Koenraadt, Noordwijk (NL); Gerard Henk Beijers, Doetinchem (NL); Kevin Jeffrey Kittle, Chester-le-Street (GB)

Correspondence Address: KENYON & KENYON LLP, ONE BROADWAY, NEW YORK, NY, 10004, US

(21) Appl. No.: 11/995,517

(22) PCT Filed: Jul. 11, 2006
(86) PCT No.: PCT/EP06/64088

§ 371 Date: Jun. 30, 2008

(30) Foreign Application Priority Data
Jul. 11, 2005 (EP) 05106314.7

(51) Int. Cl. C08L 67/00; C08K 5/05; B05D 5/00

(52) U.S. Cl. 427/256; 525/418; 524/77

(57) ABSTRACT

The present invention pertains to a process for preparing a powder coating composition, the process comprising the steps of:
a. providing a set of base compositions, each base composition comprising a liquid carrier and one or more constituents responsible for an intended property of the coating product, at least one base composition A being an aqueous dispersion or emulsion of a film-forming material,
b. selecting base compositions to be used to obtain the intended end product property, said base compositions comprising at least one base composition A as specified;
c. mixing the selected base compositions in a ratio suitable to obtain the intended end product property;
d. drying, preferably spray-drying, the mixture of base compositions or otherwise removing the liquid carrier(s), and
e. simultaneously or subsequently, combining the particles of the base compositions into larger particles.

Preferably, the particles of film-forming material in base composition A have a d(v,50)<5 μm. Preferably, at least one base composition A is prepared by phase inversion emulsification.

### FIELD OF THE INVENTION

The present invention relates to a process for preparing a powder coating composition, to powder coating compositions prepared by this process and to objects or articles coated with such powder coating compositions.

Powder coatings are solid compositions which are generally applied by an electrostatic spray process in which the powder coating particles are electrostatically charged by the spray gun and the substrate is earthed. Alternative application methods include fluidised-bed and electrostatic fluidised-bed processes. After application, the powder is heated to melt and fuse the particles and to cure the coating.

The compositions generally comprise a solid film-forming resin, usually with one or more colouring agents such as pigments, and optionally they also contain one or more performance additives. They are usually thermosetting, incorporating, for example, a film-forming polymer and a corresponding crosslinking agent (which may itself be another film-forming polymer). Generally, the resins have a Tg, softening point or melting point above 30° C.

The compositions are generally prepared by mixing ingredients, e.g. in an extruder, at a temperature above the softening temperature of the resin but below the curing temperature. The composition is then cooled to solidify it and is subsequently pulverised. The particle size distribution required for most commercial electrostatic spray apparatus is up to a maximum of 120 microns, with a mean particle size within the range of 15 to 75 microns, preferably 25 to 50 microns, more especially 20 to 45 microns.

### BACKGROUND TO THE INVENTION

The standard powder coating manufacturing process described above allows the manufacturer to offer commercially a range of full gloss coatings in a variety of colours.

Recently, a more flexible method of preparing products with a desired property, for example products with a range of colours and different finishes, has been developed.

In EP 0372860 A, a process is described for preparing a powder coating composition from a mixture of pre-prepared differently coloured powders wherein each of these powders is a finely divided powder coating composition prepared in the typical manner for powder coating compositions and comminuted to a low particle size such that when applied as a coating they are indistinguishable to the human eye as discrete particles. This allows the manufacturer to prepare and store a limited number of differently coloured film-forming base powders that are then mixed in the requisite proportions to prepare a final composition in the required colour. Because the powders contain relatively small particles, the mixture may be non-fluidisable, and if so the particles are agglomerated together to form a fluidisable powder which is capable of application by electrostatic spray.

WO 91/18951 describes an extension of this scheme whereby the agglomeration technique is used to incorporate other film-forming or non-film-forming components to produce a range of powder coating compositions with a range of different performance and aesthetic effects, and the specification shows the cluster structure of a resulting product. WO 00/53684 and WO 00/53685 also provide a process for the flexible preparation of powder coating compositions in which an uncoloured film-forming powder of the specified particle size is mixed with a coloured base powder of specified particle size, and the resulting powder mixture is agglomerated to form a fluidisable powder. Agglomeration is preferably carried out by a mechanical fusion process.

However, the degree of mixing of the powders in these agglomeration processes is inferior to that achieved by mixing in the molten stage in an extruder, and, for example, there is a relatively high probability of an agglomerate containing neighbouring pigment particles of similar pigmentation, which reduces efficiency and the range of achievable coating colours.

EP 1559751, which has a filing date before but a publication date after the priority date of the present document, describes a process in which curable resin particles are agglomerated in an aqueous dispersion, optionally in combination with other powder coating component particles to form aggregated particles. The aggregated particles are then coalesced to form fused particles. This is done by heating the dispersion to a temperature at or above the glass transition temperature of the resin. The fused particles are then isolated from the dispersion, e.g., by filtration.

US 2003/092799 describes provision of a set of liquid base compositions, one of which provides a film-forming material and the other containing the curing agent, which are mixed to provide a homogeneous dispersion, followed by spray-drying. The process of this reference has been found to lead to a powder coating composition which shows irregular flow.

U.S. Pat. No. 6,331,581 describes a method for colour matching a powder coating composition wherein two or more starting thermosetting powder coating compositions with an average particle size of 10 microns or less are dry-blended. The dry-blended mixture is combined with an aqueous solution or dispersion of polyethylene glycol or paraffin wax in an amount of up to 5 parts by weight per 100 parts by weight of dry-blended coating composition to agglomerate the dry-blended mixture into larger particles, which may then be dried to remove water.

EP 0962502 describes a process for preparing a powder coating dispersion wherein the various ingredients for the powder coating composition are combined, melted, kneaded, cooled and solidified, after which the crushed material is wet-pulverised to form a fine powder coating dispersion. Metallic pigments may be added to the powder coating dispersion.

U.S. Pat. No. 5,998,507 describes a process comprising dispersing and/or mixing a base resin and a crosslinking agent to form a dispersion, solidifying the dispersed compounds, and bringing the dispersed mixture into a powder state or granule state by the dispersion force of the dispersing and/or mixing machine.

U.S. Pat. No. 5,856,377 described a process in which a dispersion of resin particles is combined with a dispersion of a vinyl-based polymer. In Example 1 agglomeration takes place in the liquid phase.

U.S. Pat. No. 5,856,377 described a process in which a dispersion of resin particles is combined with a dispersion of a vinyl-based polymer. The particles are agglomerated by adapting the pH of the mixture to such a value that the vinyl-based polymer will deposit on the resin particles.

U.S. Pat. No. 5,610,269 describes a method for manufacturing thermosetting resin particles wherein an organosolvent-containing liquid thermosetting resin is dispersed in a solution containing two water-soluble polymers, the suspension is heated to agglomerate the particles, the organosolvent is removed by distillation, and the particles may be removed from the dispersion via centrifugation or filtration.

U.S. Pat. No. 3,969,547 describes a process for coating particles of a particulate solid with a polymer, wherein each coated particle encloses a singe particle of the particulate solid. This reference does not pertain to the manufacture of powder coatings.

It has been found that adequate quality control is difficult both for these processes and for the conventional powder coating manufacturing process. Since coating film colour cannot be readily predicted on the basis of the recipe of ingredients, sample coatings have to be made first, to test if the composition has the right colour. Therefore, the ability to predict and control the end product properties during the extrusion stage is restricted, and conventionally this is when ingredients are combined. Correction in the solid powder phase is hardly possible. As a result the conventional production process has limited flexibility in preparing powder coating compositions with a desired property. Similarly, in the agglomeration processes the results obtained are dependent on the mixing achieved in the agglomeration step. Friction during mixing produces bipolar charging, which induces separation and demixing. Thus, the sampling of powders pre-agglomeration and testing by agglomeration and application to the surface will not necessarily give an accurate prediction of the results achieved when the powder as a whole is agglomerated.

There is therefore a need to provide a powder preparation process that allows easier control of the properties of the end product such as colour, gloss and polymer composition as well as improved manufacturing flexibility, while also improving the homogeneity of the mixture of ingredients. Furthermore, there is a need to preserve the environmental benefits of powder coatings by avoiding the use and emission of volatile organic compounds.

### SUMMARY OF THE INVENTION

The present invention provides a process for preparing a powder coating composition, the process comprising the steps of:
a) providing a set of base compositions, each base composition comprising a liquid carrier and one or more constituents responsible for an intended property of the coating product, at least one base composition A being an aqueous dispersion or emulsion of a thermosetting film-forming material,
b) selecting base compositions to be used to obtain the intended end product property, said base compositions comprising at least one base composition A as specified;
c) mixing the selected base compositions in a ratio suitable to obtain the intended end product property;
d) drying, preferably spray-drying, the mixture of base compositions or otherwise removing the liquid carrier(s), and
e) simultaneous with or subsequent to drying, combining the particles of the base compositions into larger particles.

The larger particles manufactured via the process according to the invention do not break down under the mechanical and electrostatic forces encountered during powder coating composition use.

Base composition A is an aqueous dispersion or emulsion of a thermosetting film-forming material. This means that it comprises a film-forming binder resin and a crosslinker therefor. It is important that base composition A comprises the combination of a film-forming binder resin and a crosslinker, because it has been found that the flow of the final composition, and therewith the curing properties and the properties of the final coating layer, will otherwise be insufficient. It is noted that in addition to base composition A, further film-forming binder resins and crosslinkers can also be incorporated into the composition via other base compositions.

If more than one film-forming binder resin is used, it is preferred for each film-forming binder resin to be present as a dispersion or emulsion in water. Where appropriate, two or more of steps c, d and e may be carried out together. Usually, mixing is carried out before step d, and steps d and e are carried out together, but step (e) may alternatively be carried out after step (d). To obtain a homogeneous end product with controllable properties it is a feature of the present invention that the mixing of the base composition is carried out separately from the combining of the base compositions into larger particles.

Therefore, in a preferred embodiment of the present invention the mixing step is carried out at a temperature below the Tg of the thermosetting film-forming material in base composition A. It is further preferred for the mixing step to be carried out at a temperature below the Tg of all film-forming binders present in the mixture, e.g., at ambient temperature.

The process of the invention gives a simple process for producing a broad range of powder coatings, especially a broad colour range, from a limited number of intermediate stock ingredients. By using a liquid carrier for preparing the base compositions, especially by preparing an emulsion/dispersion, the base compositions will contain small particles, for example of size less than 5 μm. By using smaller base composition particles and because mixing of the selected base compositions takes place in the liquid carrier, the mixture achieved is very homogeneous, and issues of cohesivity and bipolar electrostatic charging and resultant de-mixing found while blending dry powders are avoided. Furthermore, good particle size control is possible and a final powder with a predictable particle size distribution may be obtained. Also, with a liquid phase as intermediate, an end product property may be measured directly (e.g. by wet paint measurement techniques) as described by J. L. Diel, September 2004, Paints and Coatings Industry Magazine p74 to 79, in contrast to current practice, where a conventional powder coating composition is extruded and micronised before being sprayed onto a panel and cured before the end product property can be assessed. This difference is particularly important in relation to the mechanical fusion processes of EP 0372860 A, WO 91/18951, WO 00/53684 and WO 00/53685, where a sample must be agglomerated before the powder is applied to the panel, thus involving an additional step before the end product property can be assessed. None of EP 0372860A, WO 91/18951, WO 00/53684 and WO 00/53685 discloses the preparation of separate dispersions or emulsions that are then mixed and the particles combined, and this feature has particular advantages in terms of flexibility and quality control. In the present invention adaptation and correction of end product properties is possible by adding a specific base composition to the liquid stage, as is common practice for wet paints, in contrast with conventional powder, where the pre-mix should be re-formulated and extruded again. Thus, quality control is possible, for example by the simple procedure of spraying or drawing down the liquid mixtures on to a test panel, drying and curing and examining the resulting coating. The properties of the end product can then easily be corrected by addition of one or more base compositions to the existing mix or, in a further batch, by adjusting the mixing ratio or by replacing one of the selected base compositions with a more suitable one.

A preferred liquid carrier is water, and at least half of all film-forming base compositions are advantageously present as an aqueous dispersion or emulsion, more especially prepared as an aqueous emulsion. By emulsification, better particle size control is obtained and a more efficient manufacturing process is achievable. Preferably, drying and combining are carried out by spray drying.

More especially, and in contrast to the compositions agglomerated by spray-drying in EP 0372860 A and WO 91/18951, at least one film-forming binder base composition, preferably the at least half of such compositions, and in some cases all such compositions, are prepared by phase inversion emulsification. Preferably a film-forming binder resin base composition has a d(v,50)<5 μm, preferably <4 μm, especially <3 μm, more especially <1.5 μm, more preferably <1 μm, very especially <0.5 μm and possibly <0.15 μm. The d(v,50) is generally above 50 nm.

As will be understood in the art, the volume percentiles d(v,x) indicate for a stated particle size (d) the percentage (x) of the total volume of the particles that lies below the stated particle size; the percentage (100-x) of the total volume lies at or above the stated size. Thus, for instance, d(v,50) would be the median particle size of the sample, and on a particle size distribution graph d(v,90) is the point on the curve read along the particle size axis where the area under the curve below this particle size represents 90% by volume of the particles. Thus, d(v,90)=3 microns indicates that 90% of the material is below 3 microns and 10% above this size. For the avoidance of doubt, it should be noted that all particle size percentages quoted herein are by volume. Particle sizes are measurable by light scattering techniques, for example using a Malvern Mastersizer or by Coulter LS Particle Size Analyzer, or by aerodynamic techniques using for example TSI's Aerosizer 3225, and unless indicated otherwise the sizes for liquid dispersions quoted in this specification have been measured by the Coulter LS Analyzer, and by TSI Aerosizer 3225 or Malvern Mastersizer for dry powder.

Preferably at least half of the film-forming binder resin base compositions in the set have the particle sizes as specified, and preferably at least half, especially all, of the film-forming binder resin base compositions selected for use will have a particle size as specified. We have found that we can utilize base compositions containing particles of small particle size and can combine them to produce a powder coating composition of suitable particle size during or after the drying stage. Accordingly, the liquid base composition mixture is converted into powder in which particles of the base compositions have been combined into larger particles such that the resulting powder has preferably d(v,90) in the range of from 10 to 120 μm, e.g. 20 to 120 μm, and/or d(v,50) in the range of from 5 to 75 μm.

Spray drying of binder dispersions provides a method for size control. The particles combine and, without wishing to be bound by theory, it appears that, in contrast to the agglomeration processes of WO 91/18951, the solids within each spray droplet can form a discrete powder particle so that, it is believed, the powder comprises a substantial proportion of substantially spherical single particles. Such particles appear to have a smooth surface and to be generally spherical in shape. Some cluster (macro-composite) structures appear also to be formed, it is believed by re-circulation of particles in the spray zone of the spray drier.

We have found that the spray-drying process allows a controlled and if desired narrow particle size distribution to be obtained, depending on the atomization conditions. It was not previously appreciated, for example, that spray-drying of liquid bases of such small particle sizes could lead to coalescence of particles to provide a final powder coating material of suitable particle size distribution.

Other combining techniques may also be used. For example, if freeze-drying is used in step (d), particles are not combined and a subsequent combining step is carried out, for example by mechanical fusion of the powder obtained, producing thereby cluster (or macro-composite) structures, in contrast to the micro-composite structure of the discrete particles believed to be formed on spray-drying. In contrast to the mechanical fusion processes of EP 0372860 A and WO 91/18951, in the present invention the individual component particles of the resulting cluster are derived from a liquid base mixture and generally have a smaller particle size.

EP 0372860 A and WO 91/18951 both mention forming agglomerates by a number of means, including mechanical fusion, granulation in which a solvent is used for the granulating agent and is subsequently removed, and spray drying of a dispersion of mixed binder compositions under conditions causing agglomeration, with formation of particles of cluster structure. In WO 91/18951 there is no specific example of spray drying a dispersion or emulsion; and although EP 0372860 A discloses spray-drying of a slurry in which the majority of the powder (i.e. more than 50% by number) is above 1 μm (and the d(v,50) would be substantially higher than this, above 5 μm and possibly up to 15 μm, depending on the spread, the slurry is formed from a mixture of differently coloured standard-sized powders comminuted together to form the mixture, and there is no preparation of individual base compositions. In contrast to the mechanical fusion processes of EP 0372860 A and WO 91/18951, in the present invention, further size reduction of the mixed bases, such as by ball milling, is not required because each base composition is prepared to the required particle size. It is a feature of the present invention, that individual base compositions are prepared as dispersions or emulsions and are then combined. Such a method provides maximum process flexibility. Moreover, in the mechanical fusion processes of EP 0372860 A and WO 91/18951, there is no disclosure of the preferred feature of phase inversion emulsification. WO 00/53684 and WO 00/53685 also disclose agglomeration or bonding of powders but do not disclose preparing base compositions in a liquid carrier. The process of the invention surprisingly. in comparison to the mechanical fusion processes of EP 0372860 A and WO 91/18951 can result in a reduction of the quantity of pigment needed to achieve a given level of colour strength or opacity or, conversely, can result in brighter colours for the same quantity of pigment. This may be explained perhaps by more efficient absorption of light by coloured pigments incorporated into base dispersions with smaller particle sizes providing a higher probability of adjacent pigments being of different colour.

Processes for dispersing film-forming binders in liquid carriers are of course common in the field of water-based or solvent-based coatings, and there have also been proposals for the preparation of powder compositions from liquid mixtures.

WO 01/28306 describes a process for the production of an aqueous powder composition dispersion by emulsification of its components during the melt mixing process. In WO 01/59016, cited above as US 2003/092799, a process is described for preparing an aqueous powder coating dispersion comprising components A and B, wherein one component is a binder and the other component is a crosslinker, and wherein one component is added to a dispersion of the other or both are mixed during addition of the aqueous medium. This process has limited flexibility to control the final end product properties, as the required ratio between A and B is determined by the stoichiometry between those components. Additionally it has been found that the products prepared by this method may show insufficient flow and crosslinking as the cure chemistry requires intimate mixing of the binder and crosslinker on a molecular level. In WO 97/45476, a mixture of solid resin and a cross-linker is melted and dispersed in water. Subsequently, the molten dispersed substance is allowed to solidify to form particles. The solid ingredients are premixed in a fixed ratio before extrusion, no separate dispersions are prepared, and for that reason the described process has limited flexibility.

EP 1211296 A describes a process for production of a powder coating composition by spray drying a solution comprising the constituent materials in a specified organic solvent. This solvent is said to avoid the production of bubbles, pinholes and the like in the final coating film and the paint film produced is described as having superior smoothness as well as no film defects. In contrast, the present invention does not rely on the use of organic solvents, and indeed the use of such solvents should be minimised, providing a benefit to the environment through the reduction of volatile organic emissions.

WO 95/28435 describes a process whereby a powder coating composition is produced by spray drying of an aqueous dispersion of a finely divided powder coating composition. In that process, the dispersed particles are agglomerated by such means as heating the dispersion before drying. It is a feature of the present invention, however, that the dispersed particles are combined either during or after drying. By this expedient it becomes possible to incorporate particles, such as pigments, which are not themselves powder coating compositions, so that these particles thereby become incorporated into the powder coating composition upon agglomeration. Furthermore, in the present invention, particle size control is achieved through adjustments to the atomising conditions during spray drying and by control of the solids content of the liquid feed, rather than by agglomerating before drying.

Moreover, none of these specifications suggests the possibility of utilising aqueous dispersions or emulsions in a mixing scheme to obtain a range of powder coating compositions with the option of controlling, not just colour or gloss, but also opacity and physical effects, and also allowing improved quality control. It is a feature of the present invention that additions are made to the binder dispersion base composition on or before drying to obtain the desired colour, finish and/or performance characteristic in the final coating. The modular and flexible nature of the process according to the invention allows easy adjustment or correction of the product composition. The process of the present invention therefore provides a simple, controllable method for the preparation of powder coatings and a reduction of stock, enabling improved flexibility in the manufacture and distribution of coatings.

### DETAILED DESCRIPTION OF THE INVENTION

The set of base compositions provided comprises two or more base compositions at least one of which is a base composition A which is an aqueous dispersion or emulsion of a thermosetting film-forming material. In addition to the film-forming binder and the crosslinker, composition A may if desired contain pigments, and optionally also other powder coating constituents. In addition to base composition A, there may be one or more further base compositions including a film-forming binder resin composition, optionally containing pigment and optionally containing crosslinker. In a preferred embodiment, one or more of the film-forming base compositions is prepared via emulsification. Emulsification provides a dispersion of these compositions having a d(v,50)<5 μm, preferably <4 μm, especially <3 μm, more especially <2.5 μm, more preferably <2 μm, very especially <1.5 μm, for example <1 μm. The d(v,50) is generally at least 50 nm, preferably at least 100 nm. Because, as with most size distributions, the particle size distribution usually follows a log-normal distribution, the mean value is usually less than the d(v,50) figure. The mean, also indicated as volume moment mean diameter, is the center of gravity of the distribution. The center of gravity of a mass (volume) distribution is defined by: XVM=_XdV/_dV where dV=X3dN: dV is the volume of dN particles of size X (Perry's Chemical Engineers' Handbook (7th Edition)). Base dispersions with a d(v,50)<4 μm may, for example, have a d(v,90)<10 μm, and preferably the d(v,90) is <10 μm or <5 μm, e.g. <3 μm, especially <2.5 μm, very especially <2 μm. The d(v,90) is generally at least 200 nm, preferably at least 500 nm D(v,90) values in the range 0.5 to 2 μm, and d(v,50) values in the range 0.1 to 1.5 μm, should especially be mentioned.

Accordingly, the present invention especially provides a process for preparing a powder coating composition, the process comprising the following steps:
a. providing a set of base compositions, each base composition comprising a liquid carrier and one or more constituents responsible for an intended property of the coating product, the set of base compositions comprising differently coloured base compositions, and at least one base composition A being an aqueous emulsion or dispersion containing a thermosetting film-forming material in which the particles have d(v,50)<5 μm,
b. selecting the base compositions to be used to obtain the intended end product property, said base compositions comprising at least one base composition A as specified;
c. mixing the selected base compositions in a ratio suitable to obtain the intended end product property;
d. drying the mixture of base compositions or otherwise removing the liquid carrier(s), and
e. combining the particles of the base compositions into larger particles, simultaneously with or subsequently to step d.

A further base composition prepared may contain, for example, a colouring pigment or a gloss-reducing agent. Thus, for example, a pigment and/or cross-linker may be present within the film-forming base composition A, but alternatively, or in addition, a pigment may be present in a separate base composition, and/or a cross-linker may be present in a separate base composition. In a preferred embodiment the set of base compositions includes one or more non-film-forming pigment base compositions.

In a preferred embodiment the set of base compositions also comprises one or more film-forming base compositions A selected from coloured and uncoloured film-forming base compositions. In another preferred embodiment, the set of base compositions includes a coloured film-forming base composition pre-mixed with a non-film-forming pigment dispersion. In a further preferred embodiment the set of base compositions includes a white-pigmented film-forming base composition. In an additional preferred embodiment, the set of base compositions includes a filler-pigmented base composition. In an additional preferred embodiment the set of base compositions includes a gloss-reducing base composition.

In addition to base composition A, one, two or more further base compositions may, for example, be prepared. For example, a kit of 3 or more, more especially 4 or more, for example 10 or more, or 12 or more, but preferably no more than 20 base compositions may be prepared, and any two or more base compositions may then be combined before the drying step in the production of the desired powder coating composition.

In one embodiment the set of base compositions comprises two or more of the following categories of base compositions (at last one of which is film-forming)
(i) a white-pigmented film-forming base composition,
(ii) an uncoloured film-forming base composition,
(iii) a filler-pigmented film-forming base composition,
(iv) a plurality of non-film-forming pigment base compositions,
(v) a plurality of non-white-coloured film-forming base compositions, each additionally containing one or more admixed non-film-forming pigment dispersions,
(vi) a base composition containing cross-linker for a film-forming base composition
(vii) a plurality of non-white-coloured film-forming base compositions not containing admixed pigment dispersions
(viii) a gloss-reducing base composition.

The use of a set of liquid base compositions comprising at least two, more especially at least three, e.g. at least four or at least five, of base compositions (i) to (vi), or of (i) to (v) should especially be mentioned.

Accordingly, the present invention also especially provides a process for preparing a powder coating composition, the process comprising the following steps:
a. providing a set of base compositions, each base composition comprising a liquid carrier and one or more constituents responsible for an intended property of the coating product, at least one base composition A being an aqueous dispersion or emulsion of a thermosetting film-forming resin, the set comprising two or more, preferably three or more, of the following categories (i) to (vi) of base compositions
   (i) a white-pigmented film-forming base composition
   (ii) an uncoloured film-forming base composition,
   (iii) a filler-pigmented film-forming base composition,
   (iv) a plurality of non-film-forming pigment base compositions,
   (v) a plurality of non-white-coloured film-forming base compositions, each additionally containing one or more admixed non-film-forming pigment dispersions,
   (vi) a base composition containing crosslinker for a film-forming base composition,
      and when two or more specified film-forming base compositions are present in the set these are compatible with each other, and optionally
   (vii) a plurality of non-white-coloured film-forming base compositions other than the pre-mixed base compositions (v), and/or
   (viii) a gloss-reducing base composition, and
b. selecting the base compositions to be used to obtain the intended end product property, said base compositions comprising at least one base composition A as specified;
c. mixing the selected base compositions in a ratio suitable to obtain the intended end product property;
d. drying the mixture of base compositions or otherwise removing the liquid carrier(s), and
e. combining the particles of the base compositions into larger particles, simultaneously with or subsequently to step d.

When two or more categories of the film-forming base compositions (i) to (iii) and (v) to (vii) are present in the set these are compatible with each other. Often they comprise the same film-forming resin. Except for base composition A, in any film-forming base composition a crosslinker may be present or absent. Base composition (viii) may be a film-forming base composition incompatible with the one or more other film-forming base compositions with which it is intended to be mixed.

More especially, a plurality of base compositions selected from the following categories 1 and 2, and optionally from category 3, will be prepared, usually all in aqueous carrier:
1. one or more film-forming base compositions, more especially one or more of the following sub-categories:
   (A) (1) a white-pigmented base composition, more especially a dispersion (e.g. a polyester dispersion), preferably prepared by emulsification, and preferably with a d(v,50)<5 μm, advantageously <4 μm, preferably <3 μm, e.g. <2.5 μm, especially <2 μm, more especially in the range of from 0.1 to 2 μm, very especially in the range of from 0.1 to 1.5 μm, and especially <1 μm.
      optionally this will contain crosslinker, or as a different option with an acid-functional polyester the crosslinker tetrakis(2-hydroxyethyladipamide) (Primid)® can be dissolved in water, or an epoxy polymer can be in a separate dispersion or emulsion, and then added at a later stage,
   (2) a clear (uncoloured) base composition, especially a dispersion (e.g. a polyester dispersion), preferably prepared by emulsification, and preferably with a d(v,50)<5 μm, advantageously <4 μm, preferably <3 μm, e.g. <2.5 μm especially <2 μm, more especially in the range of from 0.1 to 2 μm, very especially in the range of from 0.1 to 1.5 μm and especially <1 μm,
      optionally this will contain crosslinker, or as a different option with an acid-functional polyester the crosslinker Primid® can be dissolved in water, or an epoxy polymer can be in a separate dispersion or emulsion, and then added at a later stage, and/or
   (3) a filler-pigmented base composition, more especially a dispersion (e.g. a polyester dispersion), preferably prepared by emulsification, and preferably with a d(v,50)<5 μm, advantageously <4 μm, preferably <3 μm, e.g. <2.5 μm, especially <2 μm, more especially in the range of from 0.1 to 2 μm, very especially in the range of from 0.1 to 1.5 μm, and especially <1 μm.
      optionally this will contain crosslinker, or as a different option with an acid-functional polyester the crosslinker tetrakis (2-hydroxyethyladipamide) (Primid)® can be dissolved in water, or an epoxy polymer can be in a separate dispersion or emulsion, and then added at a later stage.
   (B) a clear (uncoloured) gloss-reduction base composition, more especially a dispersion, in the case of a polyester dispersion A, e.g. a dispersion of polyester with different reactivity, or an acrylic dispersion, and prepared by dispersion of a more reactive film-forming binder than A1, A2, or A3
      optionally this will contain crosslinker and/or catalyst, or as a different option with an acid-functional polyester the crosslinker Primid® can be dissolved in water, or an epoxy polymer can be in a separate dispersion or emulsion, and then added at a later stage;
2. a plurality of non-white-coloured non-film-forming or film-forming base compositions, more especially one or more of the following categories
   (C) a series of coloured non-film-forming pigment dispersions
   (D) a series of coloured film-forming base compositions, more especially dispersions (e.g. polyester dispersions), preferably prepared by emulsification, and preferably with a d(v,50)<5 μm, advantageously <4 μm, preferably <3 μm, e.g. <2.5 μm, especially <2 μm, more especially in the range of from 0.1 to 2 μm, very especially in the range of from 0.1 to 1.5 μm, and especially <1 μm.
      optionally this will contain crosslinker, or as a different option with an acid-functional polyester the crosslinker tetrakis(2-hydroxyethyladipamide) (Primid)® can be dissolved in water, or an epoxy polymer can be in a separate dispersion or emulsion, and then added at a later stage,
   (E) a series of coloured film-forming bases as in D, but where the colour strength has been standardised by addition of non-film-forming pigment dispersions
      and optionally
3. (F) one or more base compositions comprising a non-film-forming crosslinker, more especially, where there is an acid-functional polyester A1, A2, A3, B, D and/or E, the crosslinker tetrakis(2-hydroxyethyladipamide (Primid)® dissolved in water

As indicated above, at least one of the film-forming base composition is base composition A, comprising a thermosetting film-forming material.

Preferably, there will be a limited number of bases in a kit, more especially up to 20, for example 12 to 15, such compositions, colour modification being possible by the use of pigment dispersions.

The appropriate base compositions may then be mixed in the required ratio to give the desired coating formulations having
(b1) a range of colours, by controlling the relative proportions of coloured pigment base composition(s) C and/or coloured film-forming base composition(s) D and/or E in the formulation, and/or
an improved quality control by adjusting the pigment content using base composition E to compensate for variable or inadequate dispersion of pigment in the preparation of other base compositions,
(b2) a range of opacity levels by controlling the relative proportions of the white and clear base compositions A1, A2 and/or A3 and/or B and/or coloured base composition(s) C, D and/or E,
(b3) a range of different physical effects by appropriate selection of the resin(s) and/or crosslinker(s) in base composition(s) A1, A2, A3, B, D, E and/or F, and/or by control of the proportion of crosslinker to resin by addition of base composition F, or additional crosslinker-containing base composition A1, A2 or A3 (usually A2), and/or
(b4) a range of gloss levels, by controlling the relative proportion of the gloss reduction base composition B.

Usually the set includes at least one of base compositions A1, A2 and A3.

Advantageously, there will be at least 3 base compositions in the set. It may be preferred to provide at least 10 base compositions.

Advantageously, the base compositions are such that at least one of the ranges b2 and b3 or at least three of the ranges b1 to b4 can be prepared.

Advantageously, the set of base compositions includes base composition E. The use of a set of film-forming base compositions including base compositions C should especially be mentioned. The use of a set of film-forming base compositions including base compositions F should also especially be mentioned. Usefully, the base compositions are selected and mixed such that at least two of the characteristics mentioned are obtained.

In the prior art there is no disclosure of a full mixing scheme for the manufacture of powder coating compositions in a variety of finishes and/or with selected performance characteristics by mixing two or more different selected base compositions each comprising the constituents in a liquid carrier, at least one base composition being a dispersion or emulsion of a film-forming resin.

Thus, the present invention especially provides a process for preparing a powder coating composition, the process comprising the following steps:
a. providing a set of base compositions, each base composition comprising a liquid carrier and one or more constituents responsible for an intended property of the coating product, at least one base composition A comprising an aqueous dispersion or emulsion of a thermosetting film-forming resin, the set of base compositions comprising
   (i) a film-forming base composition containing an opacity-providing pigment, or two or more such compositions, and one or more of the following:
   (ii) an uncoloured film-forming base composition compatible with base composition (i),
   (iii) a set of non-film-forming pigment base compositions,
   (iv) a coloured film-forming base composition compatible with base composition (i) and containing an admixed non-film-forming pigment dispersion, or two or more such compositions, and
   (v) a base composition containing crosslinker for film-forming base composition (i)
   and optionally
   (vi) a gloss-reducing base composition, and/or
   (vii) a set of base compositions not containing admixed pigment dispersions,
b. selecting and mixing base composition (i) and one or more other base compositions to obtain
   b1 a desired colour by appropriate selection of the identity and relative proportion(s) of coloured base composition(s),
   b2a desired opacity level by appropriate selection of the proportions of the base composition(s) (i) and other base composition(s) and/or
   b3a desired physical effect by appropriate selection of the identity and relative proportions of binder and crosslinker base compositions,
      and optionally
   b4 a desired gloss level by appropriate selection of the relative proportion of the gloss-reducing base composition,
   wherein one of the selected film-forming base composition is base composition A, comprising a thermosetting film-forming material
c. mixing the selected base compositions in a ratio suitable to obtain the intended end product property;
d. drying the mixture of base compositions or otherwise removing the liquid carrier(s), and
e. combining the particles of the base compositions into larger particles, simultaneously with or subsequently to step d.

In a preferred embodiment of this process, the set of base compositions is such that at least 3, preferably at least 4, of the desired characteristics b1 to b4 can be obtained. It is also preferred for the base compositions to be selected and mixed to obtain at least two, especially at least three, of the desired characteristics. It may also be preferred for base compositions from at least 3 categories of base compositions to be selected and mixed.

Advantageously, in a process of the invention, the liquid mixture of base compositions is applied to a test panel, dried and cured and the coating examined and tested. To ensure the required specifications are met further additions of base compositions may be made, and the mixture will then be converted into a powder coating, for example by spray drying.

In a preferred embodiment the film-forming base composition(s) A has (have) a solids content in the range of from 30 to 70% by weight, preferably from 40 to 60% by weight.

Accordingly, the present invention provides a process for preparing a powder coating composition, the process comprising the following steps:
a. providing a set of base compositions, each base composition comprising a liquid carrier and one or more constituents responsible for an intended property of the coating product, at least one base composition A comprising an aqueous dispersion or emulsion of a thermosetting film-forming resin;
b. selecting the base compositions to be used to obtain the intended end product property, said base compositions comprising at least one base composition A as specified;
c. mixing the selected base compositions in a ratio suitable to obtain the intended end product property;
   and testing the mixture of base compositions or a sample thereof for the desired end product property and if necessary adjusting the mixing ratio(s) and/or identity of the base compositions selected,
d. drying the mixture of base compositions or otherwise removing the liquid carrier(s), and
e. combining the particles of the base compositions into larger particles, simultaneously with or subsequently to step d.

It is surprising that the various different ingredients can, if desired, be “assembled” or incorporated into the powder particles in this way. For example, it has generally been considered necessary to incorporate pigment with a film-forming polymer or other binder in the melt phase to give satisfactory dispersion of the pigment particle. This achievement is believed to result from providing the film-forming binder base compositions in a smaller particle size than previously considered.

In the process of the invention, the film-forming base composition A preferably is an aqueous dispersion or emulsion in which the film-forming particles have a d(v,50)<5 μm and the base compositions selected include at least one such base composition. Preferably, the set of base compositions provided includes at least one film-forming base composition A which is an aqueous dispersion or emulsion in which the film-forming particles have a d(v,50)<4 μm, preferably <3 μm, especially <2.5 μm, more especially <2 μm, still more especially <1.5 μm, and the base compositions selected include at least one such base composition. It may be preferred for the set of base compositions provided to include at least one film-forming base composition A which is an aqueous dispersion or emulsion in which the film-forming particles have a d(v,50)<1 μm, preferably <0.8 μm, especially <0.5 μm. It is also preferred for the set of base compositions provided to include at least one film-forming base composition A which is a dispersion or emulsion in which the film-forming particles have a d(v,50)≧0.1 μm and the base compositions selected to include at least one such base composition.

Preferably, the set of base compositions includes a film-forming base composition A and one or more other, compatible, film-forming base compositions which also meets the particle size requirements specified above.

It is preferred for the set of base compositions to include a gloss-reducing base composition containing an uncoloured film-forming material incompatible with the film-forming material of base composition(s) A during film formation. More preferable, the uncoloured film-forming material incompatible with the film-forming material of base composition(s) A during film-formation has a different reaction rate or gel time from the film-forming material of base composition(s) A. It is also possible for the set of base compositions to include a gloss-reducing base composition containing an uncoloured film-forming material that has a different particle size from the film-forming material of base composition(s) A.

In a preferred embodiment of the process according to the invention all compatible film-forming base compositions have a particle size as specified for base composition A.

The base compositions can be dispersions or emulsions of film-forming materials or combinations of materials that make up the powder coating composition. These may be produced by any suitable technology, more especially by physical production methods, for example precipitation, wet grinding, emulsification, dispersion or dissolution. Water-soluble cross-linkers may be in the form of a solution.

The solids content of the liquid mixture prior to drying is generally at least 0.001%, but usually at least 5%, preferably at least 10%, by weight; in general, the higher the solids content the more economic the process, as there is less liquid carrier to be removed, and, except when the constituent material is to be present in the final composition in relatively small amounts, the solids content should therefore preferably be at least 20%, often at least 30%, especially at least 40%, by weight. The upper limit on the solids content may be for example up to 70%, for example up to 60%, or, for example in the case of a very dense material, for example up to 95%, by weight. Spray drying atomisation is limited by the viscosity of the composition, which is generally dependent on the volume of solids, solids surface area, and interfacial interactions.

The set of base compositions produced comprises at least one film-forming base composition A comprising a thermosetting film-forming material containing a film-forming resin and a crosslinker. The film-forming resin (polymer) acts as a binder, having the capability of wetting pigments and other additives and providing cohesive strength between these particles and of wetting or binding to the substrate, and melts and flows in the curing/stoving process after application to the substrate to form a film.

In addition to the use of film-forming base composition A comprising a thermosetting film-forming material containing a film-forming resin and a crosslinker therefor, resin and crosslinker can be added to the composition via further base compositions, either in combination, or separately.

To ensure proper flow and proper crosslinking it is preferred for at least 5% of the total amount of crosslinker required to cure the total amount of resin in the final composition to be added via one or more base compositions which also comprise a film-forming resin (film-forming base composition A). In one embodiment 100% of the crosslinker is added via one or more base compositions which also comprise a film-forming resin.

Thus, the resin to be used can be provided by one or more separate base compositions, either solely comprising resin material, or it can be provided by one or more base compositions which also contain other ingredients besides the resin material, e.g. pigments and/or cross-linker. Any base composition may comprise any combination of materials up to and including all constituents that may make up a coating composition.

The base compositions described in the process according to the invention may be prepared by various means known in the art, including those for the production of aqueous coatings; for example wet grinding (as described, for example, in WO 96/37561 and EP-A 0 820 490), phase inversion emulsification (as described, for example, in WO 00/15721), melt dispersion (as described, for example, in WO 97/45476 and WO 01/60506), jet-dispersion (as described, for example, in EP-A 0 805 171) or for example by emulsion polymerisation. Water-soluble ingredients, such as soluble binders and/or crosslinkers, for example Primid®, may alternatively be used.

If a base dispersion comprises a mixture of resins or a mixture of one or more resins with one or more crosslinkers, then the resins and/or crosslinkers may be pre-mixed, for example in an extruder, and subsequently dispersed by one of the aforementioned methods. This method is preferred for the manufacture of base composition A.

Alternatively or in addition, as mentioned above, the set of base compositions may include one or more base compositions comprising a crosslinker for the film-forming material of one or more of base compositions A, B, D and/or E. In this embodiment adequate mixing is, however, necessary in order to allow crosslinking of the film-forming material.

Thus, for example, for an acid-functional polyester in base composition A, B, D and/or E, there may be a base composition containing an epoxy polymer or a non-film-forming crosslinker such as tetrakis(2-hydroxyethyl)adipamide (Primid®).

Provision of separate crosslinking base compositions provides flexibility in the production of different powder coating compositions. Thus, for example, two different crosslinker base compositions with different chemistries may be prepared, which gives more flexibility.

The provision of separate film-forming composition and crosslinker composition also allows the use of more reactive systems, allowing lower stoving temperatures to be used. Thus, for example, an accelerator, catalyst, co-reactant or alternative crosslinker may be provided in a separate base dispersion from the main film-forming base dispersion.

Mixed pigment/resin, pigment/crosslinker or pigment/resin/crosslinker base-compositions may be used.

A base composition may also be a dispersion of one or more pigments. Single or mixed pigment dispersions may be produced, for example using wet milling in a ball mill or with high speed dispersing equipment. Pigment press cake may be used when mixed with a suitable dispersant.

Following initial dispersion these base compositions may, for convenience of transport and storage, be mixed to form further base compositions. Furthermore these dispersions may be concentrated or diluted for convenient transport, storage or handling.

The liquid carrier for the base compositions is preferably water. Water-borne base compositions are preferred for their reduced environmental impact. The aqueous medium may contain one or more dispersing agents to promote homogeneous dispersion and the formation of particles with a more uniform particle shape and a narrower particle size distribution. Preferably, the liquid carrier for all base compositions is aqueous. More preferably, it is substantially free of organic solvent.

In a preferred embodiment of the process according to the invention, two aqueous additions are made during extrusion emulsification.

It is preferred for the phase inversion emulsification process to be carried out in the presence of a neutralising agent, which can react with the functional groups on the film-forming material. The neutralizing agent preferably is ammonia or an amine. Dimethylethanolamine or triethylamine are particularly preferred amines. It is possible to use other acid neutralizing agents such as sodium hydroxide. However there may be unwanted side effects from salt formation on drying. Neutralizing agents which are volatile are preferred where they may be removed from the coating material during drying or removed from the coating during cure.

In one embodiment of the process according to the invention at least one base composition A comprises an acid-functional polymer and substantially 35 to 70%, preferably 40 to 60%, of the acid groups are reacted with the neutralising agent.

Any suitable dispersing agent may be used, for example anionic, cationic, amphoteric or nonionic compounds or combinations thereof. Suitable examples are for instance described in C. R. Martens, Emulsion and Water-Soluble Paints and Coatings, Reinhold Publishing Corporation, 1965. The presence of relatively high amounts of non-reactive dispersing agents in a cross-linked film can have a negative impact on the final properties of the film. To avoid this, it is preferred to use dispersing agents with functional groups capable of reacting with the resin and/or the cross-linker, or to use only limited amounts of non-reactive dispersing agents with high dispersing/stabilising properties. In the production of binder dispersions, alternatively, or additionally, neutralising agents can be used which can form hydrophilic ionised functional groups (e.g., carboxylic groups, sulphonate groups and/or phosphonate groups) which are present in the resin and/or crosslinker. Typical examples of such neutralising agents are amines, ammonium hydroxide, and alkali metal hydroxides. Preferably, volatile neutralising agents are used; where a thermosetting resin is used this should have a boiling point below the curing temperature of the resin. Organic amines, preferably tertiary amines, for example dimethylethanolamine and triethylamine, are suitable examples.

The neutralising agent is suitably used in an amount to ensure partial neutralisation, e.g. of 35 to 70%, often at least 40% and often no more than 60%, for example substantially 50%, of the functional groups present on the resin or crosslinker. For example, in the case of an acid-functional polyester or other polymer resin the neutralising agent dimethylethanolamine may be used in an amount to neutralise substantially 50% of the carboxylic acid groups of the polyester. With a polyester of acid value in the range of from 5 to 75 mg KOH/g, the anionic groups may be, for example, from 0.09 to 1.3 mmol/g. Alternatively, neutralization can be effected with ammonia in an amount corresponding to between 45% and 120% of the acid value of the polymer.

The use of dispersing agents with reactive groups or the use of neutralising agents which can form anions with functional groups present on the binder and/or crosslinker enables the preparation of dispersions with a particle size d(v,50) in the range from 50 to 1500 nm and a solids content in the range of 30-70 wt. %, more especially in the range of from 40 to 60 wt. %, e.g. from 50 to 60 wt. %.

In a particularly preferred embodiment of this invention, one or more base compositions comprising film-forming binder are prepared by phase inversion emulsification. In the process of phase inversion emulsification, also known as indirect emulsification, water is added to the binder to form a water-in-oil emulsion which, after the addition of sufficient water, turns into an oil-in-water emulsion. It has been found that such a process gives a very homogeneous distribution of the material(s) used and allows optimum control of particle morphology. Powder dispersions prepared via phase inversion emulsification typically contain very small, spherical particles with a narrow particle size distribution.

Optionally, a film-forming or other base composition may be produced by phase inversion emulsification in the presence of water and an organic solvent. This is particularly suitable if the viscosity of the binder is too high or if the starting material(s) are present as a solution in an organic solvent(s). If so desired, the solvent may subsequently be removed, for example by distillation.

A desirable alternative to such use of solvents is the use of a molten binder in the emulsification process. In this case, evaporation of water and/or build-up of pressure in the process equipment should be taken into account. If the base composition contains crosslinker, in order to prevent premature cross-linking, the time during which the cross-linker is in contact with the resin at relatively high temperature should preferably be as short as possible, for example by using dispersing apparatus with short residence time, or by dispersing the molten substance(s) at lower temperature.

A particularly suitable phase inversion emulsification process is phase inversion extrusion. In this process polymer melts are processed using an extruder, preferably a twin-screw extruder, to disperse such a substance in an aqueous medium. This gives improved control of the average particle size, particle size distribution and particle shape of the particles in the dispersion. Preparation of aqueous powder coating dispersions prepared by phase inversion extrusion are described in WO 01/28306 and WO 01/59016. A degree of particle size control has been found in the phase inversion emulsification of binder components by controlling the hydrophilic and hydrophobic properties of the resin, for example by controlling the degree of neutralisation, for example through controlling the stoichiometric ratio of neutralising agent introduced in the aqueous phase to ionisable functional groups of the binder polymer.

The present invention especially provides a process for preparing a powder coating composition, the process comprising the following steps:
a. providing a set of base compositions, each base composition comprising a liquid carrier and one or more constituents responsible for an intended property of the coating product, the set of base compositions comprising differently coloured base compositions, and at least one base composition A having been prepared by phase inversion emulsification,
b. selecting the base compositions to be used to obtain the intended end product property said base compositions comprising at least one base composition A as specified;
c. mixing the selected base compositions in a ratio suitable to obtain the intended end product property;
d. drying the mixture of base compositions or otherwise removing the liquid carrier(s), and
e. combining the particles of the base compositions into larger particles, simultaneously with or subsequently to step d.

Preferably, the extrusion apparatus used includes a feeding port, an exit port, and options to add additional liquids. In a preferred embodiment a stepped concentration gradient is produced in the apparatus, one or preferably two separate additions of liquid being made. Thus, for example, the film-forming binder and optional pigment, crosslinker and/or other solid constituents are added at the feeding port, and water and neutralising agent are added at a later inlet to give a composition containing about 70 to 90% by wt solids. Further water is then added subsequently at a further inlet so that the resulting composition has a content of substantially 40-60% solids.

Desired particle sizes can be obtained by choosing the right conditions, such as mixing speed, type and number of, for example, mixing and/or transporting elements in the apparatus, solids content, temperature, pressure, feed rate, etc.

The d(v,50) particle sizes of the principal binder component emulsion(s)/dispersion(s) are preferably below 5 μm, especially below 2 μm, more preferably below 1.5 μm. D(v,50) values below 1 μm should especially be mentioned. More especially, compatible film-forming binder compositions have the particle sizes as specified. The storage stability is very good with d(v,50) particle sizes below 800 nm, and is optimised with a d(v,50) particle size below 500 nm. Below about 100 nm the base compositions needs some dilution to give an acceptable viscosity.

We have found that the ability to incorporate non-film-forming components with good dispersion during the drying/combining stage is increased by using smaller film-forming binder particles.

To limit the viscosity of the base compositions, the d(v,50) is preferably bigger than 50 nm, more preferably bigger than 80 nm. If the average particle size is more than 80 nm, high solids content dispersions can be handled more easily.

Any two or more film-forming binders in the final composition may be compatible or incompatible with each other. For example, the final composition may comprise two or more compatible film-forming binders, for example of different colour, or one or more coloured film-forming binders and one uncoloured (also compatible) film-forming binder (used, for example, to provide additional resin content to improve flow). Alternatively or in addition, two incompatible film-forming binders may be present in the final composition, for example of the same colour or one coloured and one uncoloured, to provide a reduced gloss finish. Often the different binders will be present in separate base compositions.

In a specific embodiment of the process according to the invention, the set of base compositions includes differently coloured base compositions. By adjusting the mixing ratio of a set of differently coloured base compositions a wide range of coloured products can be obtained.

Each base composition containing film-forming binder usually comprises at least 50%, preferably at least 60%, especially at least 70%, often at least 80%, up to 100% by volume of the film-forming binder A, calculated as a percentage of the total solids in the base composition, and in the mixture of selected base compositions the proportion of film-forming binder is usually at least 50%, preferably at least 60%, especially at least 70%, often at least 80%, by volume, calculated as a percentage of the total solids in a mixture of base compositions. In the mixture of base compositions, the solids content derived from film-forming base compositions usually constitutes in total at least 50%, preferably at least 60%, especially at least 70%, often at least 80%, by weight of the total solids content.

The final composition may if desired include a colouring pigment or pigments in an amount of up to 50% by weight, relative to the weight of the whole composition.

Pigments can be added individually or in combination during or after dispersing the film-forming binder(s). In a preferred embodiment pigment is mixed with film-forming binder(s) before both are dispersed, thereby enabling the formation of a dispersion with small and sphere-like particles of a narrow particle size distribution, wherein the pigment is homogeneously distributed. In another preferred embodiment, pigment is dispersed prior to mixing with film-forming binder dispersion. Also base compositions with a high concentration of pigment, so called pigment pastes, can be used.

A non-film-forming pigment base dispersion or coloured film-forming binder dispersion compatible with the first film-forming base dispersion may be used for colour tinting, for example of an uncoloured or white base composition or, especially if the additional dispersion is close in colour to the main coloured film-forming base composition, for colour adjustment of that composition. For such purposes pigment is generally present in an amount of at least 0.01% and preferably up to 15%, for example in an amount of 10 to 15% or 5 to 10%, by weight, based on the weight of the total final composition, (although, with very dense pigment, amounts up to 50% by weight are possible). The possibility of adjusting colour by this means assists production flexibility. Amounts of pigment of up to 25%, e.g. up to 5%, e.g. up to 1%, may for example be added to a white film-forming base composition.

Examples of pigments which may be used are inorganic pigments, such as, for example, titanium dioxide white, red and yellow iron oxides, chrome pigments and carbon black, and organic pigments such as, for example, phthalocyanine, azo, anthraquinone, thioindigo, isodibenzanthrone, triphendioxane and quinacridone pigments, vat dye pigments and lakes of acid, basic and mordant dyestuffs. Dyes may be used instead of or as well as pigments. A coloured base composition may contain a single colorant (pigment or dye) or may contain more than one colorant; alternatively, a base coating composition and optionally the final composition may be free from added colouring agents.

In a preferred embodiment substantially all pre-prepared coloured particles are prepared as aqueous pigment dispersions, and these become incorporated into the film-forming binder particles during or after the drying or other de-watering-operation. In contrast, substantially all pigment required for opacity control, for example titanium dioxide, may be dispersed throughout the film-forming binder by melt compounding before or during the formation of the aqueous dispersion.

Furthermore, fillers can be present, e.g., barium sulphate, calcium sulphate, calcium carbonate, silicas or silicates, such as talc, feldspar and/or china clay, used inter alia to assist opacity, whilst minimising costs, or more generally as a diluent. Calculated on the film-forming binder content the total pigment/filler/extender content may be, for example, 0% to 55% by volume, 0% to 50% by volume, 10% to 50% by volume, 0% to 45% by volume, or 25% to 45% by volume. Of the total pigment/filler/extender content, a pigment content of ≦40% by volume of the film-forming binder content may be used. Usually a pigment content of 25-30% or 35% is used, although in the case of dark colours opacity can be obtained with <10% by volume of pigment.

More especially, film-forming base composition A contains white pigment, for example in an amount of 30 to 40%, calculated on the weight of that base composition, or 20 to 40%, calculated on the weight of the final powder coating composition, and/or filler in an amount of 30 to 40%, calculated on the weight of that base composition, or 20 to 40%, calculated on the weight of the final powder coating composition, up to a maximum of pigment and filler of, for example, 20 to 50%, calculated on the final composition; other pigments are preferably in separate base compositions.

Alternatively, or additionally, the set of base compositions may include dispersions of compounds serving to obtain other end product properties, for instance gloss reduction.

The presence of incompatible components or components that generate incompatibility (both film-forming and non-film-forming) may be used to produce gloss reduction and/or texture in the powder coating.

The incompatibility during film formation can be achieved, for example, by the use of polymers of different chemistry that are immiscible during curing. For example, an acrylic component and a polyester, epoxy, polyester-epoxy or polyurethane component are incompatible, and cannot be blended to form a single (stable) phase. Incompatibility during film formation can also be achieved by using components that are initially miscible (compatible) but that become immiscible during curing. Thus, for example, two systems of similar chemistry and approximately the same gel time are compatible, but components with different gel times are initially compatible but become incompatible as curing (and molecular weight build-up) proceeds.

Materials that are incompatible during film-formation can separate into different phase domains which can give rise to incompatibility effects such as matting. Aside from this, the presence of two materials of different surface tension at the surface of the film and in discrete areas/domains can lead to surface disruption (texturing).

Thus gloss can be influenced by using a base composition of dispersed particles that can either disrupt the film forming process by their physical presence or through providing local variations in the curing reactivity which lead to micro-wrinkling of the coating surface. Such processes are well known in the coatings art and are described in detail in Paint flow and pigment dispersion by TC Patton (New York: John Wiley, 1976).

In one embodiment of the invention a film-former having a different curing time from that of the main film-former and initially compatible therewith is used to reduce gloss; for example for acid-functional polyester as main base component A, an acid-functional polyester with a different functionality and/or different acid value and hence different gel time may be used. Usually the gloss-reducing binder will have a higher functionality and/or higher acid value and hence lower gel time. The use of catalyst in the gloss-reduction base composition should also be mentioned. Another possibility is to employ as gloss-reducing additive a polymeric material that is per se incompatible with the polymeric film-forming material of one or more of the base compositions, for example, for a polyester an acrylic polymer as gloss-reducing additive.

The gloss-reducing additive is preferably uncoloured or, for example, the same colour as the first component. Alternatively, it may be formulated in a colour appropriate for adding to a number of different colours. For example, a red gloss-reducing additive could be prepared for adding to a range of red gloss coating compositions, a blue or white gloss-reducing additive could be prepared for adding to a range of blue gloss coating compositions, etc. Usually, however, the gloss-reducing base composition is uncoloured to provide high formulation flexibility with minimum stock holding.

In a preferred embodiment film-forming base composition A, D and/or E comprises a polyester and the gloss-reducing agent is an uncoloured base composition comprising a polyester of higher functionality. Increased amounts of this film-forming base leads to increased reduction of gloss.

Suitably, the gloss-reducing base composition (that is, the solids content of the base) is present in an amount of less than 40%, usually no more than 30%, preferably no more than 20%, by weight, relative to the weight of the final powder coating composition, although higher amounts are possible if the binder is slower gelling than the binder of base composition A, D and/or E. Suitably, if present, the gloss-reducing agent is present in the final powder coating composition in an amount of 0.5% by wt or more, often 10-25% by weight, of the final composition.

A gloss-reducing base composition having at least 90% by volume of particles <50 μm, more especially at least 90% by volume <40 μm, and with a preferred d(v,50) particle size in the range of from 1.5 to 25 μm, should be mentioned. Such base compositions may be produced, for example, by dry grinding followed by aqueous dispersion.

Alternatively, the gloss-reducing agent may have the particle size mentioned above for the main film-former of base composition A, D and/or E.

The modular approach and the ability to incorporate materials intimately and in a controllable manner into the powder particles is a significant feature of the present invention. We have found especially that spray drying of our dispersions or emulsions can produce powders with a controllable size distribution, and that such processes can be operated to give a powder composed of particles that are essentially single particles in contrast to the raspberry-structure particles produced by mechanical fusion and other processes shown for example in WO 91/18951.

The function of coatings is of course protective and aesthetic, and the film-forming resin and other ingredients are selected so as to provide the desired performance and appearance characteristics. In relation to performance, coatings should generally be durable and exhibit good weatherability, stain or dirt resistance, chemical or solvent resistance and/or corrosion resistance, as well as good mechanical properties, e.g. hardness, flexibility or resistance to mechanical impact; the precise characteristics required will depend on the intended use. The final composition must, of course, be capable of forming a coherent film on the substrate, and good flow and levelling of the final composition on the substrate are required. Accordingly, within a film-forming base, in addition to film-forming binder resin and optional crosslinker, pigment and/or filler there are generally one or more performance additives such as, for example, a flow-promoting agent, a wax, a plasticiser, a stabiliser, for example a stabiliser against UV degradation, or an anti-gassing agent, such as benzoin, an anti-settling agent, a surface-active agent, a UV-absorber, an optical whitener, a radical scavenger, a thickener, an anti-oxidant, a fungicide, a biocide, and/or an effect material, such as a material for gloss reduction, gloss enhancement, toughness, texture, sparkle and structure and the like. The following ranges should be mentioned for the total of the performance additive content of a film-forming polymeric material: 0% to 7% (preferably 0 to 5%) by weight, 0% to 3% by weight, and 1% to 2% by weight.

If performance additives are used, they are generally applied in a total amount of at most 5 wt. %, preferably at most 3 wt. %, more specifically at most 2 wt. %, calculated on the final composition. If they are applied, they are generally applied in an amount of at least 0.1 wt. %, more specifically at least 1 wt. %, calculated on the final composition

As with pigments, these standard additives can be included during or after dispersing the binder components, but for optimum distribution it is preferred that they are mixed with the binder components before both are dispersed.

The film-forming polymer used in the manufacture of a film-forming component of a thermosetting powder coating material according to the invention may, for example, be one or more selected from carboxy-functional polyester resins, hydroxy-functional polyester resins, epoxy resins, functional acrylic resins and fluoropolymers.

Suitable thermally curable cross-linking systems for application as a coating composition are for example acid/epoxy, acid anhydride/epoxy, epoxy/amino resin, polyphenol/epoxy, phenol formaldehyde/epoxy, epoxy/amine, epoxy/amide, isocyanate/hydroxy, carboxy/hydroxyalkylamide, or hydroxylepoxy cross-linking systems. Suitable examples of these chemistries applied as powder coatings compositions are described in T. A. Misev, Powder Coatings Chemistry and Technology, John Wiley & Sons Ltd., 1991.

A film-forming component of the powder coating material can, for example, be based on a solid polymeric binder system comprising a carboxy-functional polyester film-forming resin used with a polyepoxide curing agent. Such carboxy-functional polyester systems are currently the most widely used powder coatings materials. The polyester generally has an acid value in the range 10-100, a number average molecular weight Mn of 1,500 to 10,000 and a glass transition temperature Tg of from 30° C. to 85° C., preferably at least 40° C. Examples of commercial carboxy-functional polyesters are: Uralac® P3560 (DSM Resins) and Crylcoat® 314 or (UCB Chemicals). The poly-epoxide can, for example, be a low molecular weight epoxy compound such as triglycidyl isocyanurate (TGIC), a compound such as diglycidyl terephthalate condensed glycidyl ether of bisphenol A or a light-stable epoxy resin. Examples of Bisphenol-A epoxy resins are Epikote® 1055 (Shell) and Araldite® GT 7004 (Ciba Chemicals). A carboxy-functional polyester film-forming resin can alternatively be used with a bis(beta-hydroxyalkylamide) curing agent such as tetrakis(2-hydroxyethyl) adipamide (Primid® XL-552).

To improve dispersibility, the resin may contain self-emulsifiable groups. It has been found that this helps to produce smaller particle sizes in the dispersed phase. Suitable examples of such self-emulsifiable groups are acid-functional groups, such as carboxylic acid-, sulphonic acid- or phosphonic acid-functional groups.

In a preferred embodiment at least one base composition A comprises an acid-functional polyester and the set of base compositions includes a base composition containing tetrakis(2-hydroxyethyl)adipamide or an epoxy polymer for crosslinking.

Mixing of the selected base compositions may be achieved by any means known to those skilled in the art and can be carried out in a wide variety of known mixing apparatus in a ratio suitable to obtain the intended end product property. Examples of suitable mixing apparatus are described in Perry's Chemical Engineers Handbook by Perry & Green, published by McGraw-Hill in 1997. For example a stirred tank or an in line mixer such as a static mixer may be used.

In a preferred embodiment of the process according to the invention the mixture of base compositions or a sample thereof is tested for the desired end product property and if necessary adjustment of the mixture ratio(s) and/or the identity of the base compositions is made before drying. More preferably, the desired end product property is regularly tested and adjusted by using a control loop.

In batchwise or semi-continuous operation, following mixing and before drying, a quality control test may be made wherein a small quantity of the material is sampled and a coating is prepared and coating properties determined. Adjustments to the composition may be made and further tests and adjustments made, and the batch dried when the desired properties are achieved. This can be done as part of a standard quality control process.

Separation of the mixture of selected base compositions from the carrier is made by removal of the liquid carrier from the base composition or vice-versa. This may be by drying, filtration, centrifugal separation, or by evaporation or any combination of such means. Separation by drying of the mixture of selected base compositions is preferably done by spray-drying, although other drying techniques, for example rotary drying and freeze drying, may be used if so desired. Spray-drying may be carried out, for example, using an inlet air temperature up to 220° C., often up to 200° C., for example up to 180° C. A suitable minimum is, for example, 80° C., and an inlet temperature in the range of 100 to 200° C., often 150 to 200° C., should especially be mentioned. The outlet temperature may be, for example, in the range of from 20 to 100° C., more especially 30 to 80° C., preferably in the range of from 55 to 70° C., e.g. substantially 55° C., 65° C., or 70° C. In co-current spray drying, which is preferred for heat-sensitive materials, the dispersion and the hot air pass through the dryer together and the particles remain relatively cool through surface water evaporation. It has been found that the atomisation process and the water content control the particle size of the powder produced as the solids content of each atomised liquid droplet dries to form a powder particle. In the atomisation process, increasing atomisation pressure, decreasing orifice dimensions and decreasing feed rate all decrease particle size, as does decreasing the solids content of the feed. Spray drying is particularly suitable for producing powders with d(v,50) values larger than 10 μm. This technique is particularly suitable for substances that are too soft or too tough for conventional grinding. Further detail is given in Dr K Masters, Spray Drying Handbook, John Wylie & Sons, New York 1991. Spray drying may be followed by secondary drying to remove bound water as required, for example using a fluidised bed.

Freeze drying separates the particles from water by converting the water first into ice, which is then extracted by sublimation at a reduced pressure. The formation of interstitial ice may be used as an anti-coagulation stage. Lyophilisation is a special type of freeze drying described in detail by Thomas Jennings in Lyophilisation—Introduction and Basic Principles (Technomic Publishing AG, Switzerland). Lyophilisation is particularly advantageous if the concentration of any salts and dissolved organic solvents as a result of ice formation presents a problem. In lyophilisation, the temperature is maintained such that all the interstitial liquid is solidified. Hence the particles are first separated from the entire dispersing medium before and during sublimation.

If a drying method is used which does not lead to combination into larger particles, the powder composition should be agglomerated after drying to increase the particle size for greater fluidity during handling and application. Agglomeration methods to form macro-composite particles in which individual component powders are fused or bonded together to form cluster, or macro-composite, particles are described in EP 0372860A. Generally these agglomerated powders have a d(v,90) up to a maximum of 120 μm. EP 0372860 A, however, does not describe mixing of liquid dispersions, drying and subsequent agglomeration. Reference should also especially be made to agglomeration methods and to the powders produced, given in our concurrently filed application with the title Powder Coating Materials, with inventors J. Ring, S. Spencer, and A. Cordiner, the text of which is herein incorporated by reference. According to that application, mechanical fusion is advantageously carried out by gentle heating to a temperature for example in the range of the Tg of the powder to Tg+8° C., and the temperature held for a period of at least 2 mins. As described in our concurrently filed application, gentle conditions are preferably used. Thus, for example, a relatively low rate of heating is used for the mechanical fusion, with for example a heating rate of ≦4° C. per min, advantageously ≦2° C. per min, for example a rate of no more than 1° C. per minute, especially over the final 5° C. before the desired temperature is reached.

The invention also provides the final powder coating composition prepared by the process of the invention, and provides a process for forming a coating on a substrate, which comprises applying that powder coating material to a substrate, and forming the applied powder into a continuous coating over at least a part of the substrate. The powder may, for example, be heated to melt and fuse the particles and where appropriate cure the coating.

Powder coating compositions of the present invention may if desired be mixed with one or more fluidity-assisting additives before use (in a “post-blending” process). Such additives (also called flow aids) and how they are used are well known in the field of powder coatings. Suitable additives include, for example, aluminium oxide (alumina) and hydrophobic or hydrophilic silica. Preferably, however, those additives disclosed in WO 00/01775 or in WO94/11446 are used. The disclosures of those documents are herein incorporated by reference.

A preferred fluidity-assisting additive is the preferred additive combination disclosed in WO 94/11446, comprising aluminium oxide and aluminium hydroxide, preferably in proportions in the range from 30:70 to 70:30. Another preferred fluidity-assisting additive is the preferred additive combination disclosed in WO 00/01775, namely a wax-coated silica, optionally in combination with aluminium oxide and/or aluminium hydroxide. Where wax-coated silica is used in combination with alumina, the ratio between these materials is preferably 70:30 to 30:70. Where wax-coated silica is used in combination with aluminium hydroxide the ratio between these materials is preferably 80:20 to 50:50. Where a combination is used of wax-coated silica, aluminium oxide and aluminium hydroxide, the relative proportions of the additives preferably are as follows: 10-30 wt. % of wax-coated silica, 20-85 wt. % of alumina, and 1-55 wt. % of aluminium hydroxide, all calculated on the total of the three components.

Other post-blend additives which may be mentioned include aluminium oxide and silica also (hydrophobic or hydrophilic), either singly or in combination. The amount of fluidity-assisting additive(s) incorporated by dry blending may be in the range of from, for example, 0.05 or 0.1 to 5% by weight, based on the total weight of the composition without the additive(s).

Each fluidity-assisting post-blended additive is generally in finely divided form and may have a particle size up to 5 microns, or even up to 10 microns in some cases. Preferably, however, the particle size is not greater than 2 microns, and is more especially not greater than 1 micron.

When the fluidity-assisting additive comprises two or more products it is strongly preferred for at least this component to be pre-mixed, preferably intimately and homogeneously by a high shear technique, before being blended with the composition. The case where the post-blend additive includes wax-coated silica, and that material is incorporated and post-blended separately, should also be mentioned.

The term “post-blended” in relation to any additive means that the additive has been incorporated after the extrusion or other homogenisation process used in the manufacture of the powder coating material, and in the case of agglomerated powders, after the agglomeration process. Post-blending of an additive may be achieved, for example, by blending in a “tumbler” or other suitable mixing device or by introduction into the fluidised bed itself.

In the final powder coating composition prepared according to the invention, the film-forming resin, including any crosslinker or curing agent therefore is generally present in an amount of at least 50 wt. %, more specifically at least 60%, still more specifically at least 65 wt. %. It is generally present in an amount of at most 95 wt. %, more specifically at most 85 wt. %. All this is calculated on the weight of the powder coating composition without post-blended additives.

As indicated above, the powder coating composition manufactured with the process according to the invention may or may not contain a pigment. If a pigment is used it is generally present in an amount of 0.1-40 wt. %, more specifically, 5-35 wt. %. The exact amount of pigment will depend on the specific circumstances, including the colour of the pigment. Usually a pigment content of 20 to 35 wt. % is used, although in the case of dark colours opacity can be obtained with 0.1-10% by weight of pigment. All this is calculated on the weight of the powder coating composition without post-blended additives.

The powder coating composition that can be obtained with the process according to the invention, especially when a spray-drying step is employed, is characterised by the fact that it comprises spherical particles comprising individualised domains Within the context of the present specification the word spherical is intended to refer to particles with the general shape of a sphere; absolute sphericality is not required.

The presence of individual domains in the particles of the final powder coating is caused by the agglomeration of the particles present in the various base compositions. The particles of the various base compositions can still be recognised in the final powder coating composition. The sphericality of the particles is caused by the agglomeration process, in particular the spray-drying process.

A powder coating composition prepared according to the invention may in principle be applied to a substrate by any suitable process of powder coating technology, for example by electrostatic spray coating, or by fluidised-bed or electrostatic fluidised-bed processes, and especially by the tribo-charging electrostatic fluidised bed processes of WO 99/30838, WO 02/98577, WO 2004/052557 and WO 2004/052558. The process and powders of our concurrently filed application with the title Powder Coating Process, with inventors J. Ring, M. Falcone, R. Barker, and A. Cordiner, should especially be mentioned, and the text thereof is incorporated herein by reference.

After application of the powder coating material to a substrate, conversion of the resulting adherent particles into a continuous coating (including, where appropriate, curing of the applied composition) may be effected by heat treatment and/or by radiant energy, notably infra-red, ultra-violet or electron beam radiation.

The powder is usually cured on the substrate by the application of heat (the process of stoving), generally for a period of 10 seconds to 40 minutes, at a temperature of 90 to 280° C., until the powder particles melt and flow and a film is formed, usually for a period of from 5 to 30 minutes and usually at a temperature in the range of from 150 to 220° C., although temperatures down to 90° C. may be used for some resins, especially epoxy resins, and temperatures up to 280° C. are also possible. The curing times and temperatures are interdependent in accordance with the composition formulation that is used, and the following typical ranges may be mentioned:

| Temperature/° C. | Time |
|---|---|
| 280 to 90 | 10 s to 40 min |
| 250 to 150 | 15 s to 30 min |
| 220 to 160 | 5 min to 20 min |

The film may be any suitable thickness. For decorative finishes, film thicknesses as low as 20 microns should be mentioned, but it is more usual for the film thickness to fall within the range 25-120 microns, with common ranges being 30-80 microns for some applications, and 60-120 microns or, more preferably, 60-100 microns for other applications, while film thicknesses of 80-150 microns are less common, but not rare.

The substrate may comprise a metal (for example aluminium or steel) or other conductive material, heat-stable plastic material, wood, glass, or a ceramic or textile material. Advantageously, a metal substrate is chemically or mechanically cleaned prior to application of the material, and is preferably subjected to chemical pre-treatment, for example with iron phosphate, zinc phosphate or chromate. Substrates other than metallic substrates are in general preheated prior to application or, in the case of electrostatic spray application, are pre-treated with a material that will aid such application.

The present invention also provides a substrate coated with a powder coating composition produced by the present invention.

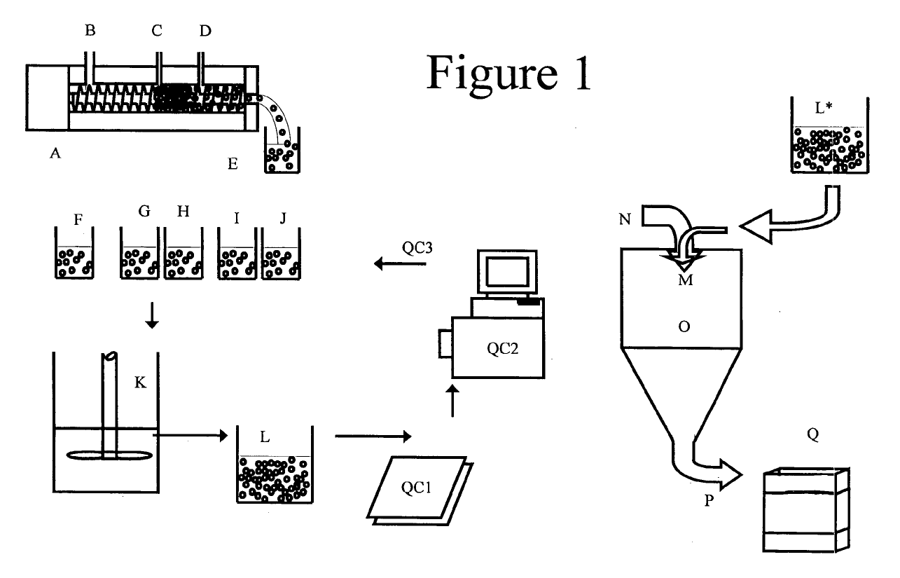

The invention is further described and illustrated by FIG. 1-5 of the accompanying drawings.

FIG. 1 shows a schematic representation of a preferred embodiment of the process according to the present invention.

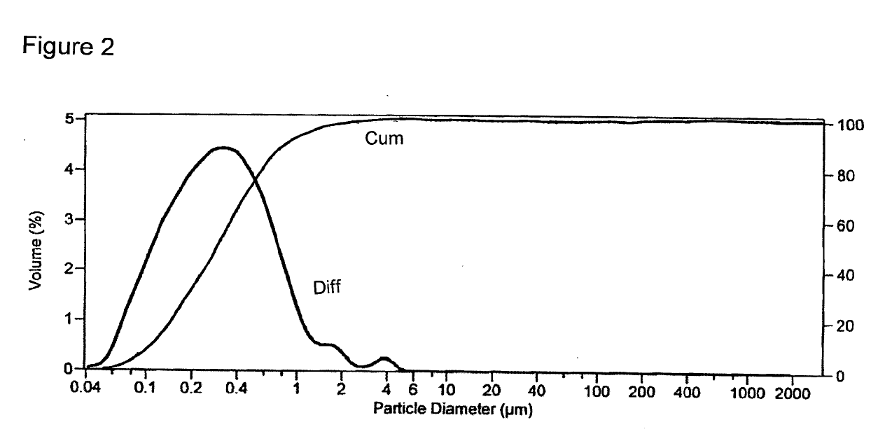

FIG. 2 shows the particle size distribution of the particles of a film-forming base composition suitable for use according to the invention.

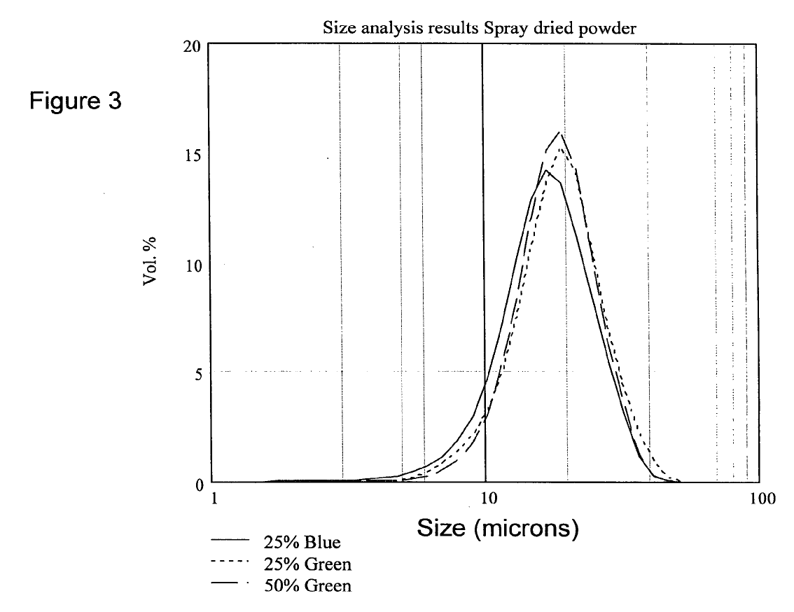

FIG. 3 shows the particle size distribution of three powder coating compositions produced by a process according to the invention.

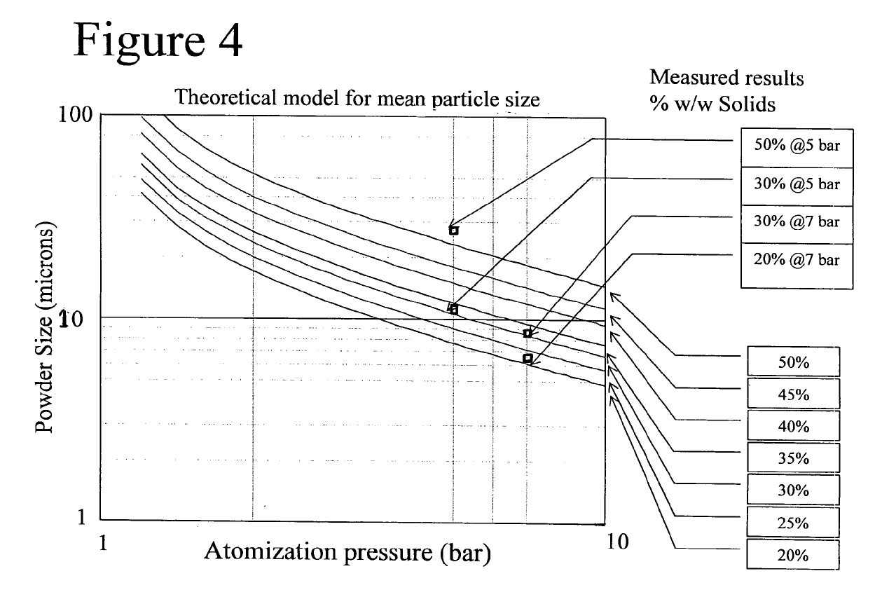

FIG. 4 shows the relationship between the atomisation conditions (atomising pressure and solids level) and the particle size of spray dried powders, as generated by modelling, together with experimental results.

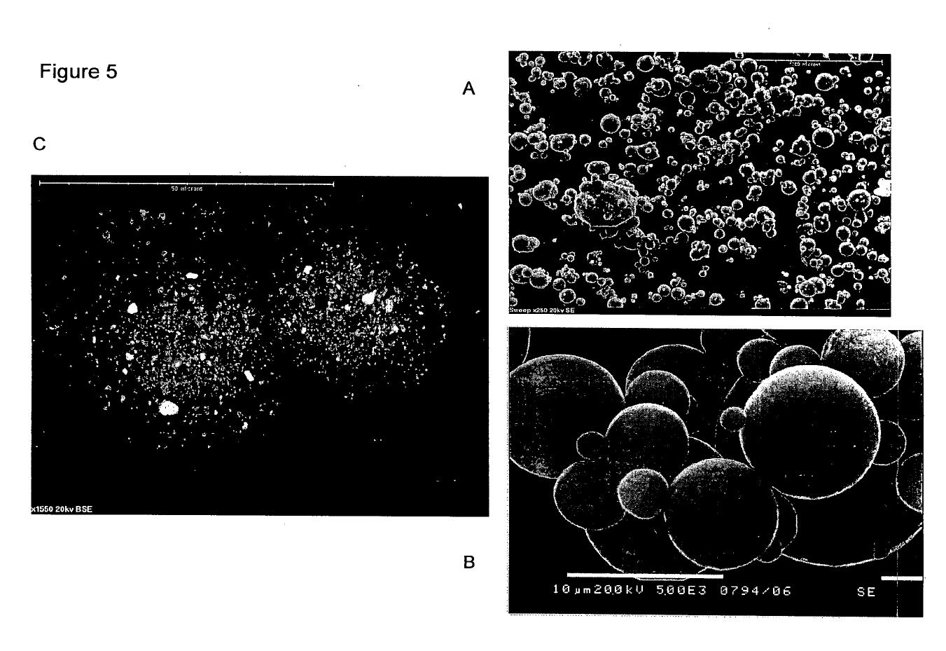

FIG. 5 shows a scanning electron microscope picture of a powder prepared by a process of the invention from base compositions prepared by phase inversion extrusion followed by spray-drying.

In FIG. 1 extruder A is fed through the main inlet B with the coating materials which are melt mixed. At point C along the extruder barrel, water and emulsifiers are introduced to the extruder to form a water-in-oil type dispersion. Further along the extruder at point D secondary water is added to the extruder, which causes phase inversion such that the water-in-oil phase is inverted to an oil-in-water type dispersion. A series of similar dispersions are represented by F, G, H, I and J, which may be produced with different pigmentation, resin, crosslinker, additives or effects. A selection of some or all of these dispersions is made, depending on the required final coating properties. The selected bases are mixed in the required proportions in mixer K to form a mixture L, a dispersion containing all the materials required in the correct proportions to form the desired powder coating. This mixture may be optionally applied to a quality control panel QC1 or otherwise presented for quality control measurement QC2 and if required adjustments made to the mixture QC3 until the required properties of the coating formulation mixture L* is prepared. This mixture is pumped to the spray nozzle M which is supplied with hot air N into the drying chamber O where evaporation of water dries the spray droplets and cools the air such that dry powder and warm air exit the dryer at P. The powder product is separated from the air stream and collected at Q.

FIG. 2 shows the particle size distribution (continuous line) of a white film-forming base composition produced by the phase inversion extrusion process described above and measured by Coulter LS Particle Size Analyzer. The particles have d(v,90) 0.840 μm, a mean of 0.434 μm and a d(v,50) of 0.295 μm. The cumulative particle size distribution is shown by the dotted line.

FIG. 3 represents the particle size distribution of certain spray-dried powders. The modal value of the green powders is very similar, whereas the blue powder has a lower modal value.

FIG. 4 shows a series of curves generated by modelling the spray drying process together with corresponding measured values. The model is based on the equations of Elkotb for Air Assist Atomiser performance with an external mixing atomiser. (Proc. ICLASS (1982) pp 107 to 115 and also in Atomisation & Sprays (Lefevre 1899) pp 233). The model was adapted for external mixing annular atomisers, e.g. Delavan AL series, which is the preferred nozzle type, with a corresponding estimation of gas velocity calculated from the work of Bayvel & Orzechowski 1993 (Liquid Atomisation, published by Taylor & Frencis). The X axis shows a logarithmic scale of atomisation air pressure and the Y axis shows the corresponding expected Sauter Mean particle size, also on a logarithmic scale. Assumptions were made that the solids contained within the individual spray droplets are aggregated on drying into a powder particle. A range of curves are shown for a range of feed solids where the solids content ranges form 20% wt to 50% wt solids. Increasing the solids content of the liquid feed will increase the particle size of the dry powder coating, and increasing atomisation pressure decreases the particle size. Measurements of the Sauter Mean Diameter (SMD) of spray dried powders shows a good agreement with the model and supports the hypothesis that individual powder particles are formed as aggregates of emulsion particles from the drying of liquid droplets, rather than the non-aggregating drying of discrete emulsion particles, in which case one would expect the same SMD to result, regardless of the degree of dilution or of the spray air pressure. The Figures are generated using the 60, 100, 120, 2-fluid (air) atomiser from Spraying Systems Co, set-up SUE 4. The model shown is for atomisation at 2.4 kg/h. Increasing the feed rate or orifice dimensions will tend to increase the particle size of the product.

FIG. 5 shows electron photomicrographs of powder coatings produced by spray drying a mixture of pigmented and non-pigmented powder coating emulsions, both prepared by Phase Inversion Extrusion. Picture A shows that a range of particle sizes were produced. It is thought that by using a peristaltic pump to feed the emulsion to the spray nozzle, fluctuations in the liquid feed rate give rise to a broad size distribution. A large composite particle appears mid left. It is thought that particles like this may be formed by the recirculation of partially dried particles into the spray area. Thus wet droplets and powder particles may aggregate into larger composite particles. Picture B shows a close-up view of the powder coating particles. The particles appear to be spherical with smooth surfaces. The slightly mottled appearance in the 500 nm range is believed to be due to the presence of pigmented and non-pigmented areas originating from the mixture of pigmented and non-pigmented emulsions in the spray dryer feed. Picture C shows a cross-section through two particles and the distribution of pigment within the body of the particles. A number of voids can be seen, which are believed to be the fossils of non-pigmented emulsion particles.

The following Examples illustrate the invention.

### EXAMPLES

### Test Methods

Viscosity of the binders described was measured by ISO 53229.

Particle size was measured for liquid systems using a Coulter LS230 particle sizer and for dry powders using a TSI Aerosizer 3225. All final powder coating compositions had d(v,90) in the 15-75 μm range.

Particle shape was determined by scanning electron microscopy.

Colour was measured according to industrial standard ASTM D65, using L, a, b coordinates.

Starting materials used in the Examples are available as indicated below.

| | |
|---|---|
| ALBARYT ® | Barytes, available from SACHTLEBEN CHEMIE; |
| benzoin | degassing agent, commercially available from DSM; |
| Byk ® 190 | dispersant available from Byk |
| Byk ® 024 | defoamer, available from Byk; |
| Byk ® 022 | defoamer, available from Byk; |
| Byk ® 380 | levelling agent, available from Byk; |
| Crylcoat ® 150 | catalyst masterbatch, available from UCB; |
| Heucosin ® Fast | blue pigment, available from Heubach; |
| Blue G1737 | |
| Irganox ® 245 | antioxidant, available from Ciba-Geigy; |
| Kronos ® | titanium dioxide pigment, commercially available from |
| | Kronos; |
| Orotan ® 731 K | dispersant available from Rohm and Haas; |
| Perenol ® F30P | flow agent, available from Henkel; |
| Primid ® XL 552 | water-soluble hydroxyalkylamide cross-linker, |
| | commercially available from EMS; |
| Rheocin ® R | thixotropic agent, available from Süd-Chemie; |
| Rheoloate ® 1 | polyacrylate thickener, available from Rheox; |
| Sicopal ® L1100 | yellow pigment, available from BASF; |
| Sipernat ® 820A | micro-extender filler, available from Degussa. |
| Tego LA-D649 | dispersant available from Degussa |

For spraying, in each case the powder was used with an addition of 0.1% of a fluidising additive consisting of a 55:45 mixture of aluminium hydroxide and aluminium oxide, calculated on the weight of the powder and additive. The aluminium oxide was Aluminium Oxide C, ex Degussa, mean particle size <0.2 microns, and the aluminium hydroxide used was Martinal OL 103C, ex Omya Croxton & Garry, mean particle size 0.8 microns. The additive was blended with the powder using a standard tumbler for at least 20 mins.

### Preparation of Base Compositions

### Example A

### Preparation of an Uncoloured Base Composition Containing Polyester Powder Resin

An aqueous dispersion of an acid functional polyester powder coating resin (acid number 24-26 mg KOH/g, functionality 2.0, Tg 55° C., viscosity 4-4.5 Pa·s at 200° C.) was produced by the phase inversion extrusion process as described in WO 01/28306. For this process 1000 grams of the polyester resin was dosed into the intake feed zone of an extruder which was heated to a temperature around 90° C.

In the first feeding point of the extruder 164 grams of an aqueous solution containing 12.5% by weight of dimethylethanolamine and 90 grams of water were added at a constant rate. Just before the end of the extruder, at a next feeding point, 764 grams of water was added thereby obtaining a white, milk-like dispersion with a solids content of 50 wt. % and a pH of 7.2. The mean size of the spherical-like particles was 136 nm; d(v,90)=197 nm; d(v,50)=130 nm.

### Example B

### Preparation of a White Base Composition Containing Polyester Powder Resin, Crosslinker, Pigment and Other Coating Additives

A white base composition of a pigmented polyester based powder coating was prepared by feeding 1000 grams of a pre-extruded powder coating composition comprising of the following ingredients: 550 grams of an acid functional polyester resin (acid number 24-26 mg KOH/g, functionality 2.0, Tg 55° C., viscosity 4-4.5 Pa·s at 200° C.), 20 grams Primid® XL552, 375 grams Kronos® 2160, 25 grams barium sulphate, 4 grams benzoin, 8 grams Rheocin® R, 15 grams Perenol® F30 P and 3 grams Irganox® 245 to an extruder which as heated up to a temperature of about 110° C. After cooling down the molten mixture to 90° C., in the first feeding point of the extruder 63.2 grams of an aqueous solution containing 12.5% by weight of dimethylethanolamine and 132 grams of water were added at a constant rate. Just before the end of the extruder, at a next feeding point, 800 grams of water was added thereby obtaining a white, milk-like dispersion with a solids content of around 50 wt. % and a pH of 7.0. The mean size of the spherical-like particles was 350 nm; d(v,90)=451 nm; d(v,50)=708 nm.

### Example C

### Preparation of a Yellow Base Composition Containing Polyester Powder Resin, Crosslinker, Pigment and Other Coating Additives

A yellow base composition of a pigmented polyester based powder coating was prepared by feeding 1000 grams of a pre-extruded powder coating composition comprising the following ingredients: 614.1 grams of an acid-functional polyester resin (acid number 24-26 mg KOH/g, functionality 2.0, Tg 55° C., viscosity 4-4.5 Pa·s at 200° C.), 22.3 grams Primid® XL552, 330 grams Sicopal® L 100, 4.5 grams benzoin, 8.9 grams Rheocin® R, 16.8 grams Perenol® F30 P and 3.4 grams Irganox®245 to an extruder which as heated up to a temperature of about 110° C. After cooling down the molten mixture to 90° C., in the first feeding point of the extruder 90.4 grams of an aqueous solution containing 12.5% by weight of dimethylethanolamine and 163 grams of water were added at a constant rate. Just before the end of the extruder, at a next feeding point, 778 grams of water was added thereby obtaining a yellow, milk-like dispersion with a solids content of around 49 wt. % and a pH of 7.0. The average size of the spherical-like particles was 298 nm; d(v,90)=914 nm; d(v,50)=375 nm.

### Example D

### Preparation of a Blue Base Composition Containing Polyester Powder Resin, Crosslinker, Pigment and Other Coating Additives

A blue base composition of a pigmented polyester powder coating was prepared by feeding 1000 grams of a pre-extruded powder coating composition consisting of the following ingredients: 687.5 grams of an acid-functional polyester resin (acid number 24-26 mg KOH/g, functionality 2.0, Tg 55° C., viscosity 4-4.5 Pa·s at 200° C.), 25 grams Primid® XL552, 150 grams Heucosin® Fast Blue G1737, 100 grams barium sulphate, 5 grams benzoin, 10 grams Rheocin® R, 18.8 grams Perenol® F30 P and 3.7 grams Irganox®245 to an extruder which as heated up to a temperature of about 110° C. After cooling down the molten mixture to 90° C., in the first feeding point of the extruder 110 grams of an aqueous solution containing 12.5% by weight of dimethylethanolamine and 138 grams of water were added at a constant rate. Just before the end of the extruder, at a next feeding point, 743 grams of water was added thereby obtaining a blue dispersion with a solids content of around 50 wt. % and a pH of 7.1. The average size of the spherical-like particles was 323 nm; d(v,90)=760 nm; d(v,50)=151 nm.

### Example E

### Preparation of an Uncoloured Base Composition Containing Polyester Powder Resin, Crosslinker and Coating Additives for Gloss Reduction

A clear powder coating with high reactivity was prepared by the general extrusion method containing 32.5% w/w ALBARYT®, 0.4% w/w benzoin, 0.2% Carnauba wax, 0.2% Irganox® 245, 1.6% Perenol® F30P, 1.1% Rheocin® R, 57.5% acid-functional polyester powder coating resin (acid number 70-90 mg KOH/g, functionality 2.0, Tg 55° C., viscosity 4-4.5 Pa·s at 200° C.), 6.5% w/w Primid® XL 552. The extruded mixture was cooled, broken into chips and micronised to give a mean particle size of around 20 microns. A 50% w/w dispersion of this powder was prepared in water using 2% w/OROTAN 731 K 25% DISPERSANT to form a gloss reduction base composition. The particles produced had d(v,50)=25 μm.

### Example F

### Preparation of a Base Composition Containing a Green Pigment

A millbase was prepared containing 45% w/w Heliogen Green 11.25% w/w Byk® 190 and 1% w/w Byk® 024 antifoam, the remaining being water. The materials were passed through a laboratory bead mill until Hegman gage results were clean indicating that the pigment was well ground.

### Example G

### Preparation of a Base Composition Containing White Pigment

A millbase of 77 wt. % TiO₂ pigment, 0.2 wt. % of a defoamer BYK® 022, 1.9 wt. % of Orotan® 731K (25%) and 20.9 wt. % water was mixed using a high speed disperser to form a highly concentrated white pigment paste.

### Example H

### Preparation of an Uncoloured Base Composition Containing Polyester Powder Resin, Crosslinker and Other Coating Additives

A pigment-free clear polyester base composition was prepared by feeding 1000 grams of a pre-extruded powder coating composition comprising 875 grams of an acid-functional polyester resin (acid number 34-36 mg KOH/g, functionality 2.19, Tg 55-65° C., viscosity 3.5-5.5 Pa·s at 200° C.), 46 grams Primid® XL552 (EMS), 4 grams benzoin, 2 grams Rheocin® R, 16 grams Perenol® F30 P and 2 grams Irganox®245, 20 grams Crylcoat® 150 (UCB), 20 grams Sipernat® 820A (Degusa) to an extruder which as heated up to a temperature of about 110° C. After cooling down the molten mixture to 90° C., in the first feeding point of the extruder 90.4 grams of an aqueous solution containing 12.5% by weight of dimethylethanolamine and 163 grams of water were added at a constant rate. Just before the end of the extruder, at a next feeding point, 778 grams of water was added thereby obtaining a white, milk-like dispersion with a solids content of around 49 wt. % and a pH of 7.0. The mean size of the spherical-like particles was 298 nm; d(v,90)=340 nm; d(v,50)=169 nm.

### Example I

### Preparation of a Base Composition Containing Crosslinker

A solution of Primid® XL552 in water was prepared by dissolving 40 g of Primid XL552 in 250 g de-ionised water.

### Example J

### Preparation of a Base Composition Containing a Green Pigment

A heliogen green pigment dispersion was prepared by dispersing 187.5 g of PG7-Heliogen Green pigment L8735 with 312.5 g of Tego dispersant (LA-D649) in water. The pigment paste was passed through a bead mill until Hegman gauge results were clean.

### Example K

### Preparation of Non-Film-Forming Base Compositions

The following aqueous, non-film-forming base compositions were prepared. The pigment paste was passed through a bead mill until Hegman gauge results were clean.

| Reference | Pigment | % Pigment | % Dispersant |
|---|---|---|---|
| Kₐ | Heliogen blue L 6905 F | 35 | 7.7 |
| K_{b} | Heliogent Green L 8735 | 43.5 | 7.8 |
| K_{c} | Colour Black FW 200 | 10 | 10.7 |

### Preparation of Final Powder Compositions

### Example 1

### Preparation of a Powder Coating by Mixing and Spray-Drying of Selected Base Compositions

A mixture was prepared of the base compositions as described in Examples B, C and D: 50% white, 25% blue and 25% yellow (percentages being by weight, calculated on the solids content). This mixture was dried at a rate of 2.4 kg/h using a compact laboratory spray dryer by Drytec, of Tonbridge, Kent, in co-current mode using a 2-fluid (air) atomiser, inlet air temperature of 150° C., outlet temperature 70° C. to produce a 50% green powder coating that was applied by electrostatic spray and cured to form a uniform coating with similar coatings properties as if all the ingredients had been processed as a normal powder coating.

### Example 2

### a) Preparation of a Powder Coating by Mixing and Spray Drying of Selected Base Compositions

A mixture of dispersions was prepared using the base compositions as described in Examples B, C, D and H containing, by weight, 50% white, 25% clear, 12.5% blue and 12.5% yellow (calculated on solids contents). This mixture was dried at a rate of 2.4 kg/h using a compact laboratory spray dryer by Drytec, of Tonbridge, Kent, in co-current mode using a 2-fluid (air) atomiser, inlet air temperature of 150° C., outlet temperature 70° C. to produce a 25% green powder coating that was applied by electrostatic spray and cured to form a uniform coating with similar coatings properties as if all the ingredients had been processed as a normal powder coating.

Comparisons were made between the 50% and 25% green powder coatings thus formed in Examples 1 and 2. Both were found to have a similar particle size. In both Examples, the particles were of generally spherical appearance.

The colour of the coatings thus formed from the 50% and 25% green powders were also examined using standard ASTM D65, 100 aperture and including specular components. Comparison of Example 1 (L 72.58 a−26.64, b 33.11) and Example 2 (L77.93, a−23.96, b 32.31) showed a significant difference in colour (overall change) ΔE=6.03, a significant difference in lightness ΔL=5.35, a red/green difference Δa 2.68, and a yellow/blue difference Δb=−0.8.

### b) Preparation by Freeze-Drying and Subsequent Agglomeration

The mixture as prepared for Example 2a was placed in a flask and frozen by immersion of the flask in liquid nitrogen. The flask was then attached to a vacuum system and held under vacuum for 12 hours. A reduction of the pressure indicated drying was completed. A fine cohesive powder was formed.

The product was then agglomerated into composite particles by mechanical fusion by mixing using a Mixago CM3 mixer wherein the temperature of the surrounding water jacket is set to 55° C. (the Tg of the powder) and the mixer speed is set to give a heating rate of 2° C. per minute, heating being continued until the powder reaches 50° C., and the mixer speed is then changed to give a temperature rise of 1° C. per minute until the powder reaches 55° C., the powder being then kept at that temperature for 2 minutes.

Comparison was made between the sample prepared in Example 2a. No distinction could be made on visual inspection.

### Example 3

### Preparation of a Powder Coating Composition by Mixing and Spray-Drying of Selected Base Compositions

2200 grams of a base composition of an acid-functional polyester powder coating resin, prepared as described in Example A, was mixed with 634 grams of an aqueous base composition of titanium dioxide pigment paste, prepared as described in Example G, and 40 grams of the Primid® XL552 solution prepared in Example I. The mixture with a solids content of 50 wt. % thus contained 69.5 wt. % of polyester resin (on solids), 28 wt. % pigment (on solids) and 2.5 wt. % of crosslinker (on solids). This material was spray dried at a rate of 2.4 kg/h using a compact laboratory spray dryer by Drytec, of Tonbridge, Kent, in co-current mode using a 2-fluid (air) atomiser, inlet air temperature of 150° C., outlet temperature 70° C., to produce a powder coating that could be applied by electrostatic spray and cured to form a uniform coating with similar properties as if the ingredients had been processed as a normal powder coating.

### Example 4

### Preparation of a Range of Reduced-Gloss Powder Coatings

### a) Gloss Reduction (25% Gloss-Reduction Base)

A mixture was prepared containing the following base compositions:—
971 g of a white base composition of Example B above
253.6 g of a yellow base composition of Example C above
251.0 g of a blue base composition of Example D above
500 g of a clear gloss reduction base composition of Example E above
   This was diluted to a shear thinning viscous liquid at 30% w/w/solids.

### b) Gloss Reduction (15% Gloss-Reduction Base)

A mixture was prepared containing the following base compositions:—
971 g of a white base composition of Example B above
253.6 g of a yellow base composition of Example C above
251.0 g of a blue base composition of Example D above
300 g of a clear gloss reduction base composition of Example E above
232.0 g of a clear base composition of Example H above
   This was diluted to a shear thinning viscous liquid at 30% w/w/solids

The mixtures described in a and b above were spray dried using a compact laboratory spray dryer by Drytec, of Tonbridge, Kent, in co-current mode using a 2-fluid (air) atomiser, inlet air temperature of 150° C., outlet temperature 70° C., to produce powder coatings that were applied by electrostatic spray and cured to form a uniform green coatings showing a range of reduced gloss levels when compared to the coating prepared in Example 2.

### Example 5

### Preparation of a Coloured Powder Coating by Pigment-Tinting a White Base

100 g white base composition as prepared in Example B above
111 g of the green base composition as prepared in Example F above
889 g of a clear base composition as prepared in Example H above

The mixture described above was spray dried at a rate of 2.4 kg/h using a compact laboratory spray dryer by Drytec, of Tonbridge, Kent, in co-current mode using a 2-fluid (air) atomiser, inlet air temperature of 130° C., outlet temperature 55° C., to produce a powder coating that was applied by electrostatic spray and cured to form a uniform green coating.

### Example 6

### Preparation of a Coloured Powder Coating by Pigment Tinting a White Base

1000 g white base composition of Example B above
55.5 g of the green base composition of Example E above
944.5 g of a clear base composition of Example H above

The mixture described above was spray dried at a rate of 2.4 kg/h using a compact laboratory spray dryer by Drytec, of Tonbridge, Kent, in co-current mode using a 2-fluid (air) atomiser, inlet air temperature of 130° C., outlet temperature 55° C., to produce a powder coating that was applied by electrostatic spray and cured to form a uniform green coating.

### Example 7

### Providing and Using a Colour Database to Predict the Ratio of Bases Required to Produce a Desired Colour

Using film-forming bases from Examples B and H and non-film-forming base compositions from Example K, the following mixtures were prepared and spray dried to produce powder coatings as described by earlier Examples using inlet temperature 150° C. and outlet temperature between 55 and 60° C.

| | | | | | Non-film- | |
|---|---|---|---|---|---|---|
| | Film-forming base | | Film-forming base | | forming base | |
| Sample | Base | Wt (g) | Base | Wt (g) | Base | Wt (g) |
| K7.1 | H | 1500 | — | — | K_{b} | 136.67 |
| K7.2 | B | 1643 | H | 329 | K_{b} | 17.24 |
| K7.3 | H | 2000 | — | — | Kₐ | 241.38 |
| K7.4 | B | 1500 | H | 293 | Kₐ | 20.51 |
| K7.5 | H | 1500 | — | — | K_{c} | 406.55 |
| K7.6 | B | 1500 | H | 292 | K_{c} | 45.82 |
| K7.7 | B | 1500 | H | 209 | K_{c} | 21.73 |

| | Colour measurements D65, 10 deg. | | | | |
|---|---|---|---|---|---|
| Sample | L | A | B | C | H |
| K7.1 | 27.42 | −7.04 | −5.64 | 9.02 | 218.73 |
| K7.2 | 77.29 | −40.54 | 0.96 | 40.55 | 178.64 |
| K7.3 | 26.17 | 6.35 | −10.07 | 11.91 | 302.21 |
| K7.4 | 40.60 | −5.98 | −40.11 | 40.55 | 261.52 |
| K7.5 | 23.53 | 0.08 | −0.05 | 0.50 | 279.33 |
| K7.6 | 49.94 | −0.16 | 0.74 | 0.76 | 102.2 |
| K7.7 | 59.54 | −0.31 | 0.71 | 0.77 | 113.66 |
| B | 91.05 | −0.72 | 2.98 | 3.07 | 103.52 |

Using the formulation data and colour data it was found possible to estimate the required formulation to prepare a desired colour.

The colour database was used to give a formulation to prepare a standard colour RAL 6004 using Datamatch application V.181© datacolour International.

| | Film- | | Film- | | Non-film- | | Non-film- | | Non-film- | |
|---|---|---|---|---|---|---|---|---|---|---|
| | forming base | | forming base | | forming base | | forming base | | forming base | |
| | base | Wt (g) | base | Wt (g) | Base | Wt (g) | base | Wt (g) | base | Wt (g) |
| RAL | B | 500 | H | 1598 | K_{b} | 107.78 | Kₐ | 23.22 | K_{c} | 42.82 |
| 6004 | | | | | | | | | | |

The predicted formulation (above) was prepared and dried to give a powder coating as with the other examples.

| | Colour measurements D65, 10 deg. | | | | |
|---|---|---|---|---|---|
| Sample | L | a | B | C | H |
| Reference data (target) | 33.69 | −13.55 | −3.14 | 13.91 | 193.05 |
| RAL 6004 (dried) | 34.81 | −14.08 | −3.75 | 14.57 | 194.90 |
| Difference | 1.12 | −0.54 | −0.61 | 0.67 | 0.46 |

Thus the overall colour difference (ΔE CMC) was found to be 1.18 which is generally considered a close colour match and is considerably better than is commonly achieved for a first prediction by the process described in EP 0372860A.

### Comparative Example

### Powder Coating with the Same Formulation as Example 1 Prepared by Bonding Without Use of Liquid Bases

A powder coating was prepared by first micronisation and then jet milling of the individual pre-extruded components used in Examples B, C and D so that powders were formed with the same ingredients as the base compositions used in Example 1 and such that the d(v,90) particle size of these were substantially below 10 λm. These powders were mixed in the same ratios as for Example 1 and agglomerated by allowing the temperature to rise above the softening point and then cooling during the mixing process. In this way a 50% green powder coating was produced that could be applied by electrostatic spray and cured to form a uniform coating with similar coatings properties as if all the ingredients had been processed as a normal powder coating.

The colour of the coatings thus formed from the spray dried and bonded 50% green powders of Example 1 were also examined using standard ASTM D65, 10° aperture and including specular components. In comparison with Example 1 (L 72.58 a−26.64, b 33.11) the Comparative Example (L=73.07, a=−21.48, b=22.69) showed a significant difference in colour ΔE=11.64, in lightness ΔL=0.49, red/green Δa=5.16, yellow/blue Δb=−10.42. The Δb value showing a significantly bluer shade and the similar ΔL lightness values from the powder composition as described in Example 1 produced in the process according to the invention correspond to the expected improvements in pigment efficiency as described earlier.

1. A process for preparing a powder coating composition, the process comprising the steps of:
a) providing a set of base compositions, each base composition comprising a liquid carrier and one or more constituents responsible for an intended property of a coating product, at least one base composition A being an aqueous dispersion or emulsion of a thermosetting film-forming material,
b) selecting base compositions to be used to obtain an intended end product property, said selected base compositions comprising at least one base composition A;
c) mixing the selected base compositions in a ratio suitable to obtain the intended end product property;
d) drying the mixture of base compositions or otherwise removing the liquid carrier(s), and
e) simultaneous with or subsequent to step d), combining the particles of the base compositions into larger particles to form the powder coating composition.

2. A process according to claim 1, wherein the particles of film-forming material in base composition A have a d(v,50)<5 μm.

3. A process according to claim 1, wherein the set of base compositions comprises the base composition A and one or more separate base compositions containing a crosslinker for the film-forming material in said base composition A.

4. A process according to claim 1 wherein the set of provided base compositions comprises two or more of the following categories (i) to (vi) of base compositions
(i) a white-pigmented film-forming base composition,
(ii) an uncoloured film-forming base composition,
(iii) a filler-pigmented film-forming base composition,
(iv) a plurality of non-film-forming pigment base compositions,
(v) a plurality of non-white-coloured film-forming base compositions, each additionally containing one or more admixed non-film-forming pigment dispersions, and
(vi) a base composition containing a crosslinker for a film-forming base composition,
wherein when two or more film-forming base compositions (i), (ii), (iii) and (v) are present in the set these are compatible with each other.

5. A process according to claim 1 wherein the set of base compositions comprises
(i) a film-forming base composition containing an opacity-providing pigment, and one or more of the following:
(ii) an uncoloured film-forming base composition compatible with base composition (i),
(iii) a set of non-film-forming pigment base compositions,
(iv) a coloured film-forming base composition compatible with base composition (i) and containing an admixed non-film-forming pigment dispersion, and
(v) a base composition containing a crosslinker for film-forming base composition (i)
and wherein base composition (i) and the one or more other base compositions are selected and mixed to obtain at least one of
b1 a desired colour by appropriate selection of the identity and relative proportion(s) of coloured base composition(s),
b2 a desired opacity level by appropriate selection of the proportions of the base composition(s) (i) and other base composition(s),
b3 a desired physical effect by appropriate selection of the identity and relative proportion of the crosslinker base composition, and
b4 a desired gloss level by appropriate selection of the relative proportion of the gloss-reducing base composition.

6. A process according to claim 1, wherein the liquid carrier for all base compositions is aqueous.

7. A process according to claim 1 wherein the set of base compositions comprises a plurality of film-forming base compositions at least half of which are prepared by emulsification.

8. A process according to claim 1, wherein the base composition A is prepared by phase inversion emulsification.

9. A process according to claim 8, wherein the phase inversion emulsification is carried out in an extruder.

10. A process according to claim 8, wherein a base composition is produced in the presence of another base composition as a dispersing medium.

11. A process according to claim 1, wherein drying and combining take place simultaneously.

12. A process according to claim 1, wherein the mixture of base compositions is spray-dried at an inlet temperature in the range of from 80 to 220° C.

13. A process according to claim 1, further comprising testing the mixture of base compositions or a sample thereof for the intended end product property and if necessary adjusting the mixture ratio(s) and/or the identity of the base compositions before drying.

14. A process according to claim 1, wherein the entire process is performed continuously.

15. A kit for preparation of a plurality of powder coating compositions comprising
a set of base compositions, each base composition comprising a liquid carrier and one or more constituents responsible for an intended property of the coating product, the set of base compositions comprising differently coloured base compositions and film-forming base compositions, the majority of the film-forming base compositions being an aqueous emulsion or dispersion containing a film-forming material in which the particles have d(v,50)<5 μm, at least one base composition being an aqueous dispersion or emulsion of a thermosetting film-forming material.

16. A powder coating composition obtained by the process of claim 1, which comprises spherical particles containing individualised domains.

17. A process for forming a coating on a substrate, comprising applying a powder coating composition according to claim 16 to a substrate, and forming the applied powder into a continuous coating over at least a part of the substrate.

18. A substrate which has been coated by a process as claimed in claim 17.

19. A process according to claim 4, wherein the set of provided base compositions further comprises at least one member of the group consisting of a plurality of non-white-coloured film-forming base compositions other than the pre-mixed base compositions (v), and a gloss-reducing base composition.

20. A process according to claim 5 wherein the set of base compositions further comprises a gloss-reducing base composition,
and wherein base composition (i) and the one or more other base compositions are selected and mixed to obtain a desired gloss level by appropriate selection of the relative proportion of the gloss-reducing base composition.
